(19) United States
(12) Patent Application Publication
(10) Pub. No.: US 2026/0146710 A1
(43) Pub. Date: May 28, 2026

(54) SYSTEMS AND METHODS FOR COOLING CRYOGENIC FLUID

(71) Applicant: Daimler Truck North America, LLC, Portland, OR (US)

(72) Inventor: Kevin SLUSSER, Portland, OR (US)

(21) Appl. No.: 19/353,347

(22) Filed: Oct. 8, 2025

Related U.S. Application Data
(60) Provisional application No. 63/704,682, filed on Oct. 8, 2024.

(51) Int. Cl. F17C 1/12; F17C 13/02

(52) U.S. Cl. CPC F17C 1/12; F17C 13/021; F17C 13/025; F17C 13/026; F17C 2221/012; F17C 2223/0161; F17C 2250/0408; F17C 2250/043; F17C 2250/0439; F17C 2250/0631; F17C 2270/0168

(57) ABSTRACT

In an aspect, a system includes a cryogenic tank having a cooling system including a para-ortho catalyst device and a chiller, wherein the cryogenic tank is configured to store a cryogenic fluid, and a controller storing instructions in non-transitory memory that, when executed, cause the controller to conduct a cooling operation for the cryogenic tank via one or more of the para-ortho catalyst device and the chiller as a function of operating conditions.

### CROSS-REFERENCE TO RELATED APPLICATIONS

This application claims priority to, and the benefit of, U.S. Provisional Application No. 63/704,682 filed Oct. 8, 2024, assigned to the assignee hereof and hereby incorporated by reference herein in its entirety.

### FIELD

This disclosure relates to systems and methods to cool a cryogenic fluid. In particular, the disclosure relates to systems and methods for reducing or eliminating release of cryogenic fluid into the atmosphere.

### BACKGROUND

Liquid hydrogen storage tanks are highly insulated vessels capable of holding liquid hydrogen at −253° C. for prolonged periods of time. Even with high levels of insulation, vaporization of the hydrogen occurs which, if not used for consumption (e.g., in a hydrogen fuel cell or H₂-internal combustion engine), may need to be released to atmosphere to vent the tank to avoid overpressure conditions. When used in a vehicle for propulsive purposes, for example when used in a fuel cell, hydrogen emits no carbon dioxide. Yet when emitted into the atmosphere, hydrogen can indirectly be a contributor to climate change.

Therefore, there is a need for improvement in systems and/or methods to cool a cryogenic fluid.

### SUMMARY

Aspects of the present disclosure provide a cooling system and method of cooling a cryogenic fluid that reduces or avoids the need to release hydrogen gas to the atmosphere by sensing operating parameters of a cryogenic system and controlling cooling of the cryogenic system based on the sensed operating parameters.

In one aspect a cooling system is provided for vehicles with a cryogenic tank. The system comprises a cryogenic tank comprising a cooling system, wherein the cooling system comprises a para-ortho catalyst device and a chiller and wherein the cryogenic tank is configured to store a cryogenic fluid; and a controller storing instructions in non-transitory memory that, when executed, cause the controller to conduct a cooling operation for the cryogenic tank via one or more of the para-ortho catalyst device and the chiller as a function of operating conditions.

In aspects, the cryogenic fluid is a liquid hydrogen.

In aspects, the para-ortho catalyst device is coupled with a heat exchanger device to form a catalyst heat exchanger assembly.

In aspects, the para-ortho catalyst device is configured to be located near a region of the cryogenic tank where a temperature of an ullage gas is predicted to be highest measured over a period of time.

In aspects, the chiller is one of a thermoacoustic chiller and a thermoacoustic Stirling chiller.

In aspects, the vehicle operating conditions comprise one or more of a tank temperature, a tank pressure, a level of the cryogenic fluid, weather conditions, route conditions, a refueling need, a distance from refueling station, driving distance post refueling, and a parking time.

In another aspect, a method is provided for vehicles for cooling a cryogenic tank. The method comprises: determining operating conditions based on data received from one or more sensors of a vehicle, wherein the vehicle comprises a cryogenic tank and wherein the cryogenic tank is configured to hold a cryogenic fluid and an ullage gas in an ullage space of the cryogenic tank, sending a signal by a controller to operate, via one or more actuators, one or more of a chiller and a para-ortho catalyst device based on the operating conditions, and operating one or more of the chiller and the para-ortho catalyst device.

In another aspect, a non-transitory computer-readable medium having stored thereon instructions executable by a computer system is provided for vehicles for cooling a cryogenic tank. The non-transitory computer-readable medium having stored thereon instructions executable by a computer system to perform operations comprises determining operating conditions based on data received from one or more sensors of a vehicle, wherein the vehicle comprises a cryogenic tank and wherein the cryogenic tank is configured to hold a cryogenic fluid and an ullage gas in an ullage space of the cryogenic tank; sending a signal by a controller to operate, via one or more actuators, one or more of a chiller and a para-ortho catalyst device based on the operating conditions; and operating one or more of the chiller and the para-ortho catalyst device.

In another aspect, a system is provided for vehicles for cooling a cryogenic tank via use of a catalyst and heat-exchanger assembly and a chiller. The system for a vehicle comprising a tank configured for storing a cryogen; a catalyst and heat-exchanger assembly; a chiller; and a controller storing instructions in non-transitory memory that, when executed, cause the controller to supply a consumer of the cryogen with said cryogen in a manner in which said cryogen contacts the catalyst of the catalyst and heat-exchanger assembly; and power said chiller.

In another aspect, a system is provided for vehicles for cooling a cryogenic tank. A system for a vehicle comprising a tank configured for storing a cryogen; a catalyst and heat-exchanger assembly; a chiller; and a controller storing instructions in non-transitory memory that, when executed, cause the controller to receive a request to refuel the tank; and conduct a pre-refuel tank cooling operation by relying on both the catalyst and heat-exchanger assembly and the chiller.

In another aspect, a system is provided for vehicles for cooling a cryogenic tank when a tank pressure is above a pressure threshold. The system for a vehicle comprising: a cryogenic tank configured for storing a cryogen; a catalyst and heat-exchanger assembly; a chiller; and a controller storing instructions in non-transitory memory that, when executed, cause the controller to determine that a pressure in the cryogenic tank is above a pressure threshold; and perform one or more of: drawing an ullage gas in a manner in which said ullage gas contacts the catalyst of the catalyst and the heat-exchanger assembly; and powering said chiller.

In another aspect, a method is provided for vehicles for cooling a cryogenic tank when a tank pressure is above a pressure threshold. The method comprising determining a tank pressure based on data received from one or more sensors of a vehicle, wherein the vehicle comprises a cryogenic tank and wherein the cryogenic tank is configured to hold a cryogenic fluid and an ullage gas in an ullage space of the cryogenic tank; sending a signal by a controller to operate, via one or more actuators, one or more of a chiller and a para-ortho catalyst device; and operating one or more of the chiller and the para-ortho catalyst device to cool the cryogenic tank.

In another aspect, a system is provided for vehicles for cooling a cryogenic tank for cooling a cryogenic tank via a chiller relying on onboard energy supply. The system for a vehicle comprising a cryogenic tank configured for storing a cryogen, a catalyst and heat-exchanger assembly; a chiller; and a controller storing instructions in non-transitory memory that, when executed, cause the controller to receive a request to refuel the cryogenic tank; and conduct a pre-refuel tank cooling operation by relying on the chiller wherein the chiller draws power from an onboard energy supply.

In another aspect, a method is provided for vehicles for cooling a cryogenic tank via a chiller relying on onboard energy supply. The method comprising determining a refuel event for a cryogenic tank; sending a signal by a controller to operate, via one or more actuators, a chiller; and conducting a pre-refuel tank cooling operation by relying on the chiller wherein the chiller draws power from an onboard energy supply.

In another aspect, a system is provided for vehicles for cooling a cryogenic tank via a chiller relying on offboard energy supply. The system for a vehicle comprising: a tank configured for storing a cryogen; a catalyst and heat-exchanger assembly; a chiller; and a controller storing instructions in non-transitory memory that, when executed, cause the controller to determine that the vehicle is being parked for a parking time; and conduct a tank cooling operation by relying on the chiller, wherein the chiller draws power from offboard energy supply.

In another aspect, a method is provided for vehicles for cooling a cryogenic tank via a chiller relying on offboard energy supply. The method comprising: determining that a vehicle is being parked for a parking time; and sending a signal by a controller to operate, via one or more actuators, a chiller; and conducting a tank cooling operation by relying on the chiller, wherein the chiller draws power from offboard energy supply.

In another aspect, a system is provided for vehicles for a cryogenic tank for alerting a driver to schedule a refuel event after a prolonged parking. The system for a vehicle comprising: a tank configured for storing a cryogen; a catalyst and heat-exchanger assembly; a chiller; and a controller storing instructions in non-transitory memory that, when executed, cause the controller to determine a need for a refuel event; determine that the vehicle will be parked for a parking time; and alert a driver of the vehicle with an alert signal for the refuel event to be scheduled after the parking time.

In another aspect, a method is provided for vehicles for a cryogenic tank for alerting a driver to schedule a refuel event after a prolonged parking. The method comprising determining a need for a refuel event; determining that a vehicle will be parked for a parking time; and alerting a driver of the vehicle with an alert signal for the refuel event to be scheduled after the parking time.

In another aspect, a system is provided for vehicles for cooling a cryogenic tank via a chiller. The system for a vehicle comprising: a tank configured for storing a cryogen; a catalyst and heat-exchanger assembly; a chiller; and a controller storing instructions in non-transitory memory that, when executed, cause the controller to determine that the vehicle will be parked for a predetermined parking time; use the cryogen in a fuel cell to charge an energy storage device associated with the vehicle; and conduct a tank cooling operation by relying on the chiller, where the chiller is powered by the energy storage device.

In another aspect, a method is provided for vehicles for cooling a cryogenic tank via a chiller. The method comprising determining that a vehicle will be parked for a parking time; using a cryogen in a fuel cell to charge an energy storage device associated with the vehicle; and conducting a tank cooling operation by relying on a chiller, where the chiller is powered by the energy storage device.

### BRIEF DESCRIPTION OF THE FIGURES

The figures are furnished with the application to enable understanding of the disclosure and shall not be construed as the only way to perform the disclosure. These and other aspects of the present disclosure will now be described in more detail, with reference to the appended drawings showing exemplary aspects of the present disclosure, in which:

FIG. 1A is a vertical cross-sectional view of a cryogenic tank (also referred as tank, cryogenic storage tank, or cryogenic fuel tank) according to an aspect.

FIG. 1B is a schematic diagram of a system comprising additional components which can be included as part of or associated with cryogenic tank.

FIG. 2 is a block diagram of a vehicle comprising a control system to control cooling system for a cryogenic tank according to an aspect.

FIG. 3 is a high-level flow diagram for a method of operating the disclosed systems.

FIG. 4 is a high-level flow diagram for conducting a cooling operation of the cryogenic tank according to an aspect.

FIG. 5 is a block diagram of power sources for the chiller of the cooling system of the cryogenic tank according to an aspect.

FIG. 6 is a high-level flow diagram for conducting a cooling operation of the cryogenic tank using a chiller according to an aspect.

FIG. 7 is a high-level flow diagram for conducting pre-refuel cooling operation of the cryogenic tank according to an aspect.

FIG. 8 is a high-level flow diagram for deciding a pre-refuel cooling operation of the cryogenic tank based on current and future operating conditions according to an aspect.

### DETAILED DESCRIPTION

The following description of aspects is merely exemplary in nature and is not intended to limit the disclosure, its application, or uses.

Cryogenic storage tanks, particularly those designed for liquid hydrogen, encounter significant challenges in maintaining the cryogen at optimal conditions over extended periods. Despite advanced insulation techniques, such as vacuum jackets and other thermal barriers, heat ingress ultimately leads to the vaporization of the cryogenic fluid. This vaporization increases the pressure within the tank, requiring the release of hydrogen gas to the atmosphere to prevent overpressure conditions. While hydrogen is a clean fuel when consumed in fuel cells or hydrogen internal combustion engines, its release into the atmosphere may contribute indirectly to climate change and represents a loss of fuel. Conventional systems often rely on oversized tanks to accommodate vapor expansion or periodic venting, both of which are inefficient and environmentally unsustainable. Furthermore, existing cooling systems for cryogenic tanks are often energy-intensive, require frequent maintenance, or lack the precision to dynamically adapt to varying operating conditions, such as changes in ambient temperature, vehicle usage, or refueling needs.

The described system addresses these limitations by introducing a novel cooling arrangement that integrates a para-ortho catalyst device and a chiller, managed by a controller with advanced control logic. The para-ortho catalyst device leverages the endothermic reaction of converting parahydrogen to ortho-hydrogen to passively cool the tank, reducing the rate of vaporization and mitigating pressure buildup. This catalyst is strategically positioned in regions of the tank where ullage gas temperatures are at elevated levels, enhancing its cooling efficiency. Complementing this passive cooling mechanism, the chiller—such as a thermoacoustic or thermoacoustic Stirling chiller—provides active cooling capabilities. These chillers are designed to operate with minimal moving parts, reducing maintenance requirements and eliminating the risk of lubricant contamination in the cryogenic fluid. The system is further enhanced by a controller that dynamically adjusts the operation of the para-ortho catalyst device and the chiller based on real-time data from sensors monitoring tank pressure, temperature, fluid levels, and external conditions.

This approach not only reduces or avoids the need to release hydrogen gas into the atmosphere but also enhances energy usage by giving preference to external power sources (e.g., shore power) when accessible and utilizing onboard energy storage systems when required. The capability of the system to adjust to vehicle operating conditions—such as driving, parking, or refueling—supports cooling that is effectively aligned with specific scenarios. For example, pre-refueling cooling operations decrease tank pressure and temperature, facilitating more efficient refueling and lowering the likelihood of hydrogen loss. By integrating passive and active cooling mechanisms with intelligent control logic, the described system provides a sustainable, energy-conscious, and environmentally considerate solution to the challenges associated with cryogenic fluid storage and management.

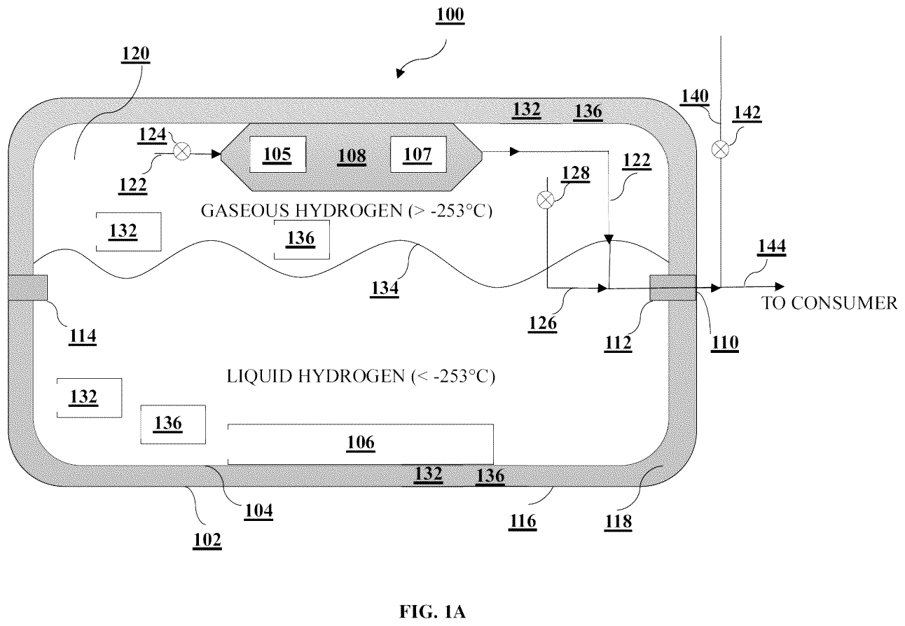

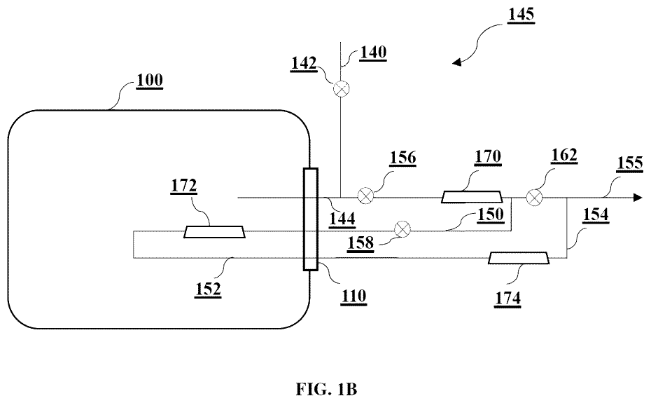

FIG. 1A is a vertical cross-sectional view of a cryogenic tank (also referred to as cryogenic storage tank, cryogenic fuel tank, or tank) 100 according to an aspect. The cryogenic tank 100 can be used in a vehicle, and the vehicle can be a hydrogen internal combustion engine (ICE) or fuel cell electric vehicle, amongst others. The cryogenic tank 100 and the methodology discussed herein is not limited to vehicles, but rather can be used in other fields of endeavor where cryogen (e.g., hydrogen) is used as a fuel. In the illustration, the cryogenic tank 100 has a cylindrical shape, though other shapes are within the scope of this disclosure. The cryogenic tank 100 comprises an inner tank (or inner vessel) 104 having a containment volume 116 and is surrounded by an outer tank (or outer vessel) 102. The outer tank 102 and/or inner tank 104 may be jacketed, for example, a vacuum jacket, to insulate the cryogenic tank 100. Space 118 between inner tank 104 and outer tank 102 could be maintained via use of tank suspensions 112 and 114. In an aspect, the suspension system may be a magnetic suspension system described in the U.S. Patent Application No. 63/653,406 filed on 30 May 2024, whose contents are incorporated herein by reference in its entirety. Space 118 may additionally be filled with an insulating material or may have vacuum. The containment volume 116 comprises cryogenic fluid or fuels maintained at or below a particular predetermined temperature. Cryogenic fuels include those liquid fuels that boil at temperatures at or below −100° C. under atmospheric pressures. Examples of cryogenic fluids include hydrogen, liquefied natural gas (LNG), nitrogen, oxygen, carbon dioxide, and methane, which are storable in liquefied form at cryogenic temperatures. In an aspect, the cryogenic fluid is hydrogen, and the cryogenic tank 100 is heavily insulated and designed to store hydrogen at about −253° C. or colder.

Cryogenic fluid in the tank 100 exists in vapor-liquid equilibrium. The gas is present in the vapor phase in the upper part of the tank and in the liquid phase in the lower part of the tank illustrated using a notional partition 134, with gaseous hydrogen, referred to as ullage gas, located above the partition and liquid hydrogen below the partition. The shape and position of partition 134 are not intended to be taken literally, as they are depicted solely for convenience and explanatory purposes. When cooled to the point of liquefaction (˜20.3 K or −252.9° C.), hydrogen is comprised of approximately 0.2% ortho hydrogen and 99.8% para hydrogen. When the liquid hydrogen absorbs heat and transitions to gaseous hydrogen it will not naturally change from its existing state of approximately 0.2% ortho and 99.8% para hydrogen and thus no thermal reaction occurs. However, para-ortho catalysts that promote the conversion of para hydrogen to ortho hydrogen are known, and the catalytic reaction is endothermic. Hence, contacting hydrogen gas with such a para-ortho catalyst can introduce a cooling effect in the cryogenic tank 100. The cooling effect can reduce temperature in the tank to limit the extent of hydrogen gas formation, which in turn can advantageously reduce or avoid fuel tank overpressure conditions where there may be a need to vent the tank to atmosphere.

In aspects of this disclosure, cryogenic tank 100 comprises catalyst and heat exchanger assembly 108 which includes catalyst 105 (e.g., para-ortho catalyst) and heat exchanger 107. The heat exchanger and catalyst can be in close proximity to one another, or separated in space, e.g., separated but in the ullage space, or separated where the catalyst is positioned in the ullage space and the heat exchanger is present in the liquid cryogen. The ullage space may include, but is not limited to, the unfilled space in a cryogenic tank that accommodates the expansion and contraction of the cryogenic fluid. It is the vapor space above the liquid in the tank. The In some aspects, the para-ortho catalyst may be present at or near a region of the cryogenic tank 100 where a temperature of hydrogen gas is predicted or inferred to be highest (e.g., highest average temperature over a period of time), and the heat exchanger may be present in close proximity to the catalyst or some distance away, for example nearer the liquid cryogen, or in some examples submerged in the liquid cryogen, (e.g., near a bottom of the tank). In an aspect, catalyst and heat exchanger assembly 108 is present near the top of the cryogenic tank, or where the highest temperature vapor is inferred or predicted in the cryogenic tank. Endothermic conversion of parahydrogen gas to orthohydrogen gas via the catalyst 105 results in a cooling effect in the tank by way of heat exchanger 107 which reduces a pressure in the tank.

Specifically, the para-ortho catalyst, as herein described, forces the endothermic reaction from the conversion of a para state of hydrogen to an ortho state of hydrogen and uses the cooling effect to reduce the temperature of the hydrogen vapor in the ullage space 120 (also referred to as the vapor space) of the cryogenic tank 100. The ullage space provides a volume for cryogenic fluid to expand, given that the cryogenic fluid will transition from liquid to vapor, in turn raising the pressure in the tank. If a storage tank were to be over-filled with a cryogen such as hydrogen, without an ullage space, even a very small amount of vaporization of the cryogen may rapidly increase pressure in the tank, because there is little space into which the liquefied gas can expand. Hence, cryogenic tanks are sized to accommodate this issue, but the need to oversize tanks render tanks quite large in comparison to the amount of cryogen they can store. As shown in FIG. 1A, the ullage space 120 comprises hydrogen gas which has temperature higher than −253° C. The ullage space 120 could have temperature stratification, for example, a region closer to the liquid cryogen may be lower in temperature, with different temperature bands corresponding to different heights of the tank, the bands increasing in temperature the closer to the top of the tank.

A benefit of using a para-ortho catalyst 105 is that an existing energy potential in the hydrogen gas is used to cool the cryogenic tank passively and, in turn, reduce rate of hydrogen vapor generation. By using internal cooling to control pressure in the tank, the need to vent the ullage gas in the tank to atmosphere to prevent overpressure conditions can be reduced or eliminated completely. The ullage gas may include, but is not limited to, the gaseous form of a cryogenic fluid present in the ullage space of a cryogenic tank, such as hydrogen vapor in the ullage space of a liquid hydrogen tank. Various examples of para-ortho catalysts that could be employed herein, without limitation, includes a paramagnetic material (e.g., ferric oxide), an activated carbon, a platinized asbestos, a rare earth metal (e.g. crude cerium oxide), a uranium compound, and a nickel compound (e.g., Nickel (5.3%) and thoria (0.24%) on Davison alumina), ruthenium, copper, platinum, palladium, manganese, ferric oxide, silver, a rare earth metal, combinations of the foregoing, or any other catalyst that promotes the conversion of parahydrogen to orthohydrogen.

In an aspect, catalyst and heat exchanger assembly 108 is at a location such that it could take advantage of the vapor stratification/temperature stratification in the ullage space 120. Discussed herein, gaseous cryogen (e.g., hydrogen) in the ullage space is referred to as “ullage gas.” For example, catalyst and heat exchanger assembly 108, shown in FIG. 1A, is positioned at the highest temperature region of ullage gas present in the tank. This may improve efficiency of the cooling ability of the catalyst and heat exchanger assembly 108.

In cryogenic tank 100, ullage gas present in the ullage space 120 is drawn into conduit 122, arranged in the ullage region when consumption of hydrogen gas is requested via controller. In aspects, ullage gas is drawn into conduit 122 for consumption by a hydrogen consumer and/or when the tank pressure and/or tank temperatures exceed a predefined threshold, discussed in further detail below. Conduit 122 may include valve 124, to regulate the flow of ullage gas into conduit 122. For example, valve 124 may be opened to draw ullage gas across the para-ortho catalyst 105 where, following conversion, the gas is directed out of the tank via outlet/inlet 110 and sent to a consumer (e.g., fuel cell not shown at FIG. 1A) for consumption. The outlet/inlet 110 may form a part of suspensions 112 and/or 114, or anywhere else through the walls of the tank 100. The valve 124 may be any valve that enables or prevents flow therethrough. In examples, valve 124 is a proportional valve or digital control valve or continuously variable valve with the degree of opening and closing of the valve adjusted according to the pressure in the tank. Pressure in the tank may be monitored, for example, via pressure sensor 136. How valve 124 is controlled, as a function of tank conditions and vehicle operating conditions, is described in greater detail below.

Tank 100 may include one or more sensors, for example pressure sensor 136 as discussed. Pressure sensors 136 may be one of capacitive pressure sensors, strain gauge pressure sensors, piezoelectric pressure sensors, silicon piezoresistive pressure sensors, and the like. Other sensors can include but are not limited to temperature sensors 132. Temperature sensors 132 may be one of platinum resistance temperature detectors (RTDs), silicon diode temperature sensors, thermocouples (e.g., type e, type t), capacitive temperature sensors, thermistors, vibrating wire temperature sensors, and the like. Sensors may further include level sensors (not shown) to measure the level of cryogenic liquid inside the tank, which may include one or more of capacitance level sensors, differential pressure sensors, ultrasonic sensors, radar level sensors, resistive chain sensors, float-based sensors, and acoustic sensors. Sensors may further include flow sensors (not shown) for measuring the flow rate of cryogenic fluids and/or cryogenic gas among others in the conduits or along the valves. Flow sensors include thermal mass flow meters, Coriolis flow meters, Coriolis flow meters, turbine flow meters, vortex flow meters, differential pressure flow meters, positive displacement flow meters etc. For example, sensors may be strategically located within the tank, outside the tank, and/or embedded or integrated within the tank walls as suitable for reliable readings and interpolations.

As mentioned above, ullage gas is drawn by way of conduit 122 to outlet/inlet 110 for consumption by a fuel cell or other hydrogen consumer. When drawn through conduit 122, the cooling effect is imparted to the tank due to the catalyst and heat exchanger assembly 108. However, there may be circumstances where it is not desired to further cool the tank. In aspects, cryogenic tank 100 may contain a bypass circuit comprising a bypass conduit 126 and a valve 128 for ullage gas to bypass the catalyst and heat exchanger assembly 108. Hydrogen gas which has bypassed the catalyst and heat exchanger assembly can be used for consumption by the fuel cell or other consumer, or in certain conditions vented to atmosphere (although control schemes disclosed herein bias towards avoiding venting to atmosphere). In one example, bypass conduit 126 may be used when the cooling effect in the tank is not desired. The valve 128 may be a proportional valve or digital control valve or continuously variable valve, similar to that described for valve 124. In some examples, the degree of opening and closing of the valve is adjusted according to the pressure sensed by a pressure sensor, for example pressure sensor 136. For example, and without limitation, opening the valve more at higher pressures and less at lower pressures. The valve 128 can be controlled as a function of operating conditions of a vehicle which relies on the cryogen (e.g., hydrogen) to at least partially propel the vehicle. In an aspect, the valves are controlled in an automated manner and electronically or digitally, for example, according to control logic. In some aspects, the tank 100 lacks a bypass circuit.

Depicted at FIG. 1A is vent line 140. Vent line stems from conduit 144, where conduit 144 is receiving ullage gas from either conduit 122 or conduit 126, depending on operating conditions of the vehicle. Vent valve 142 is associated with vent line 140 and can be controlled to open and close in similar fashion as that discussed above with regard to other valves discussed herein. When vent valve 142 is closed, hydrogen vapor is prevented from being released to atmosphere by way of vent line 140. When at least partially opened, hydrogen vapor may travel along vent line 140 for release to atmosphere. As mentioned, release of hydrogen vapor to atmosphere is undesired from an environmental perspective, hence the systems and methods described herein function to control tank temperature and/or pressure in a manner that largely or even completely avoid having to rely on the release of hydrogen vapor to atmosphere to relieve tank pressure/reduce tank temperature.

In aspects, cryogenic tank 100 may further comprise a chiller 106 configured to impart cooling to the cryogen in the tank and/or tank interior. Chiller 106 may be any of a thermoacoustic chiller, an electrocaloric cooling device, a magnetocaloric cooling device, electrocaloric cooling device, an absorption refrigerator device, etc., configured to impart cooling of cryogen to maintain/achieve cryogenic temperatures.

In an aspect, chiller 106 may be a thermoacoustic chiller. Thermoacoustic chillers are refrigeration systems that operate using sound waves to create temperature gradients within a working fluid, typically a gas. Unlike traditional refrigeration systems, thermoacoustic chillers have no, or minimal, moving parts (at least in the portion contacting a fluid to-be-cooled), making them highly reliable and free from the need for manipulation (e.g., servicing, lubrication), which is particularly beneficial in cryogenic applications. The core components of a thermoacoustic chiller may include an acoustic head, a resonator, one or more heat exchangers, and a stack or regenerator. The acoustic head of the system is where sound waves are generated. These sound waves compress and expand a gas, or working fluid in the resonator, creating temperature differences due to the thermoacoustic effect. There are several methods for generating these sound waves within the acoustic head. One common approach is to use electromechanical drivers such as loudspeakers or piezoelectric devices, which convert electrical energy into acoustic energy. Another method involves the use of thermal drivers like heating elements that create sound waves through rapid heating and expansion of the gas. Additionally, or alternatively, pressure wave generators or pistons can also be employed to mechanically induce sound waves within the system.

As the sound waves travel through the resonator, they interact with the stack or regenerator, where the actual heat transfer occurs. The temperature gradient generated by the sound waves is harnessed by the heat exchangers to absorb heat at the cold end and reject it at the hot end, effectively cooling the desired area or substance.

In an aspect, chiller 106 may be a thermoacoustic Stirling cryocooler. An integration of the Stirling cycle allows the thermoacoustic Stirling cryocooler to achieve higher efficiencies and lower temperatures than traditional thermoacoustic chillers. The thermoacoustic Stirling cryocooler is a refrigeration system that combines the principles of thermoacoustics with the Stirling cycle to achieve efficient cooling at cryogenic temperatures. Like thermoacoustic chillers, this system operates using sound waves to induce temperature gradients, but it incorporates elements of the Stirling cycle to enhance its performance, particularly for applications requiring very low temperatures. The key components of a thermoacoustic Stirling cryocooler include the acoustic driver, resonator, regenerator, displacer, and heat exchangers.

In this system, the acoustic driver generates high-intensity sound waves within the resonator. These sound waves, produced by either electromechanical devices such as loudspeakers or by thermal methods, create pressure oscillations that are central to the thermoacoustic process. The regenerator acts as a thermal sponge absorbing heat during the compression phase and releasing it during expansion. This process is synchronized with the movement of the displacer, which helps to manage the flow of gas between the hot and cold ends of the system, a key feature of the Stirling cycle. The heat exchangers positioned at both ends of the regenerator manage the heat flow, with the cold heat exchanger absorbing heat from the area to be cooled, and the hot heat exchanger dissipating it to the surroundings. Thermoacoustic chillers or Thermoacoustic Stirling chillers, in one or more aspects may be designed having no moving parts in the acoustic head or acoustic driver, which generates and sustains acoustic waves, and therefore require no lubrication, reducing the risk of contamination from lubricants, entering the liquid hydrogen. Further, because of no moving parts and no lubrication requirements in the acoustic head or acoustic driver, these chillers may eliminate the need for frequent service and maintenance requirements.

In summary, a thermoacoustic chiller or thermoacoustic Stirling chiller involves generating sound waves that create pressure and temperature variations in a resonator. These variations cause a temperature gradient across a stack, a series of closely spaced plates or porous material placed within the resonator, leading to heat absorption from one side and heat rejection from the other. This process produces a cooling effect, making it possible to achieve refrigeration without the use of traditional mechanical compressors or refrigerants. Typically, an inert gas like helium or air, which is enclosed within the engine, is used as a working gas and is subjected to cyclic temperature and pressure changes. While a standard thermoacoustic chiller relies solely on sound waves and acoustic effects to generate cooling, a thermoacoustic Stirling chiller combines these acoustic effects with the Stirling cycle. Heat exchangers positioned at warm, or hot, end and cold end of the chiller are designed and directed appropriately to facilitate heat transfer to the surroundings, i.e., cold heat exchanger is directed in the cryogenic tank to maintain the temperature of the cryogen at a desired low temperature and hot heat exchanger may be directed out of the cryogenic tank to dissipate heat out of the cryogenic tank. One example of such chillers is heat-driven thermoacoustic refrigerators (HDTRs). With this configuration, the chiller will not be a service item and will never need to be accessed, since there is no access to the inside of the liquid hydrogen tank.

In an aspect, the thermoacoustic chiller 106 is mounted inside of cryogenic tank 100 and packaged in the liquid space to provide cooling to cryogenic fluid, i.e., liquid hydrogen. In an aspect, chiller 106 could be packaged in the vapor space or ullage space 120. In an aspect, there could be more than one chiller, for example, one placed in the ullage space 120 and the other placed in the cryogenic liquid. In an aspect, the chiller 106 is partially placed into the cryogenic fluid. In an aspect, the chiller 106 may be formed from a combination of multiple thermoacoustic device stages, such as individual thermoacoustic refrigerators, connected in a looped series such that excess acoustic energy from a first stage forms a part of the input energy to the next successive stage as disclosed in US patent having U.S. Pat. No. 8,584,471B2 whose contents are incorporated herein in its entirety. Other variations and combinations of having catalyst and heat exchanger assembly 108 and chiller 106 and their placement in the cryogenic tank 100 are contemplated herein.

For example, chiller 106 may include heat-driven thermoacoustic refrigerator (HDTR). In an aspect, direct-coupling HDTR comprises a thermoacoustic engine and cooler, which are interconnected via a thermal buffer tube (TBT) as presented in Xiao et al., Cell Reports Physical Science, Volume 5, Issue 3, 20 Mar. 2024, Pages 101867. In another aspect, chiller 106 may be a thermoacoustic chiller which is a pulse tube refrigerator system as described in U.S. Pat. No. 6,430,938B1, whose contents are incorporated herein in their entirety. In an aspect, there could be more than one thermoacoustic device connected in series as described in U.S. Pat. No. 8,584,471B2 whose contents are incorporated herein in their entirety. In an aspect the chiller 106 may be a thermoacoustic cryocooler as described in Jiaxin Chi, Liubiao Chen, Geng Chen, Yuan Zhou, Ercang Luo, Jingyuan Xu, Numerical study on a heat-driven thermoacoustic cryocooler operating near liquid-helium temperature ranges, Applied Thermal Engineering, Volume 216, 2022, 119085, ISSN 1359-4311, https://doi.org/10.1016/j.applthermaleng.2022.119085. The above examples are meant to be illustrative and non-limiting.

The chiller 106 (e.g., thermoacoustic (TA) chiller) may be mounted at the bottom of the tank, although other positions within the cryogenic tank 100 are contemplated. Position of the chiller 106 in the cryogenic tank 100 may be selected based on a primary objective being to impart cooling to liquid hydrogen, serving to bias the liquid hydrogen to remain in the liquid state and in turn regulate (e.g., lower) pressure in the tank. In an aspect, the TA chiller may receive energy to power the cooling action via an external energy source.

In an aspect, the system comprises a thermoacoustic Stirling cryocooler or thermoacoustic chiller in the cryogenic tank to perform a maintenance free cooling with no moving parts. In aspects, such a chiller may be included within a vacuum space (e.g., space 118 in FIG. 1A), at least partially, to optimize where the heat is directed. In aspects, such a chiller may pass through the vacuum insulated space to the exterior of the tank. The power output for cooling may be sized to enable a desired amount of cooling. Via the addition of the chiller 106, the cryogenic tank is enabled to provide additional means of cooling configured to substantially reduce or completely eliminate any need to vent the tank to atmosphere. By relying on the systems and methodology discussed herein, an amount of hydrogen vapor vented to the environment may be reduced by 25% to 99%, or even 100%, such as 30%, 40%, 50%, 60%, 70%, 80%, 90% as compared to systems lacking such cooling capabilities.

It is herein recognized that it may be possible to coat at least a portion of the inner linings of the inner tank 104 of tank 100 with the para-ortho catalyst (e.g., catalyst 105). In aspects, at least a portion of the inner lining of the ullage space is coated with the para-ortho catalyst. In other aspects, the coating of a portion of the inner lining is avoided. For example, it is recognized that an advantage of the present disclosure is that having a catalyst configured in a manner by which flow of ullage gas across the catalyst 105 is controllable, and enhanced control over cooling is realized. Specifically, lining/coating even a portion of the inner lining of the tank may result in large quantities of parahydrogen being converted to orthohydrogen, and this hydrogen may be liquified via reliance on the chiller 106. The reliquification of hydrogen and corresponding slow conversion back to parahydrogen may cause a heating effect that would, in turn, undesirably drive additional vaporization of the hydrogen.

Turning now to FIG. 1B, depicted is system 145 including cryogenic tank 100, illustrating some additional components, which can be included as part of or associated with cryogenic tank 100. Shown is conduit 144, outlet/inlet 110, vent line 140 and vent valve 142. The system 145 can be controlled in a manner that either 1) reintroduces some heat into tank 100 with the goal of increasing cryogen vaporization to supply additional ullage gas to the consumer for consumption, or 2) avoids reintroduction of any heat to tank 100 with the goal of maintaining or reducing pressure in the tank 100. Specifics will be discussed in relation to the methods disclosed herein. Briefly, in the first scenario mentioned above, ullage gas exiting tank 100 via conduit 144 may proceed through valve 156 (with vent valve 142 closed). The gaseous hydrogen receives heat via heat exchanger 170, and with valve 162, when closed, routes flow of the gaseous hydrogen along conduit 150 and through valve 158 in open or partially open position. The warmed gaseous hydrogen is introduced into tank 100, where heat exchanger 172 operates to exchange heat from the gaseous hydrogen into the tank. The cooler gaseous hydrogen then exits the tank 100 via conduit 152, where it then warmed/heated via heat exchanger 174 and flows through conduit 154 and conduit 155 just prior to use in a consumer (e.g., fuel cell). In this way, heat is reintroduced to the tank 100 to cause vaporization of cryogen in a controlled manner, with the goal of generating more ullage gas for use.

In the second scenario, valve 162 may be controlled (e.g., commanded open) such that ullage gas exiting the tank 100 is warmed via heat exchanger 170, and is used for consumption (e.g., in a fuel cell) without being rerouted back to the tank 100. In this case, valve 158 is controlled to be closed to prevent the warmed gaseous hydrogen from being reintroduced to the tank 100. Vent valve 142 is also maintained closed to avoid release of any gaseous hydrogen to atmosphere.

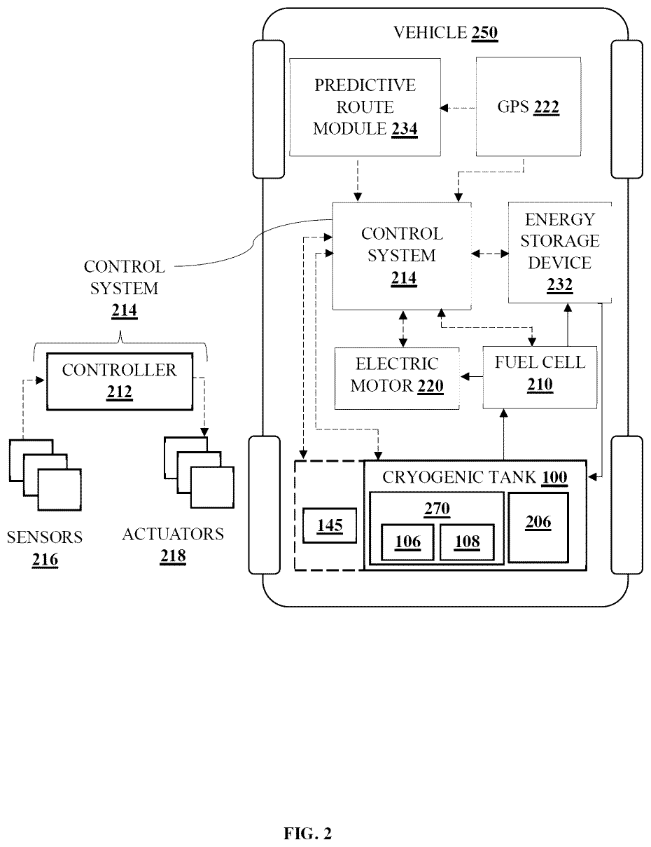

Turning to FIG. 2, systems of the present disclosure may be controlled via a control system 214 according to a control logic. Control system 214 may communicate with one or more of cryogenic tank 100 including system 145 as explained in FIG. 1B, electric motor 220, fuel cell 210, energy storage device 232, global positioning system (GPS) 222, and Predictive route module 234. Control system 214 may receive sensory feedback information from one or more of cryogenic tank 100 including system 145, electric motor 220, fuel cell 210, energy storage device 232, GPS 222, and Predictive route module 234. Further, control system 214 may send control signals to one or more of cryogenic tank 100 including system 145, electric motor 220, fuel cell 210, and energy storage device 232. Further, control system 214 may receive an indication of an operator from a vehicle operator (not shown in the figure). For example, control system 214 may receive GPS location from GPS 222 and planned route information from predictive route module 234. Control system 214 may include controller 212, which may receive information from sensors 216 (e.g., temperature sensors 132, pressure sensors 136 at FIG. 1A), and may in turn control one or more actuators 218 (e.g., actuators associated with valves, such as valve 124, 128, 142, etc., at FIG. 1A, or actuators associated with chiller 106, for example powering the chiller 106, and so on). The control logic may comprise instructions to control various aspects relating to cooling system 270, which comprises catalyst and heat exchanger assembly 108 and chiller 106 at FIG. 1A, and/or various components of system 145 at FIG. 1B (e.g., valves 142, 156, 158, 162), fuel cell 210, and so on. For example, the fuel cell 210 (or H₂ internal combustion engine in aspects) and/or pumps associated with the system (not shown) can draw gaseous hydrogen from tank 100 for consumption. Valve control by the control system can determine the route the gas takes based on the vehicle's current operating conditions to enable cooling or warming of the cryogenic tank 100.

Shown at FIG. 2 is vehicle 250. Vehicle 250 may be operated by a human operator, at least partially operated by a human operator, or may be autonomously (e.g., fully autonomous without a driver in the vehicle) operated. According to the aspect depicted at FIG. 2, fuel cell 210 is coupled to cryogenic tank 100, and is controlled via control system 214 to power vehicle 250 via electric motor 220. Although not specifically shown, electric motor 220 may be used to propel the vehicle. Energy produced by the fuel cell may be used directly in the vehicle, for example for propulsive purposes, or may be stored for later use in an energy storage device 232 (e.g., battery). In aspects, sensors may be removably or fixedly installed within the vehicle and may be disposed in various arrangements to provide information to the autonomous operation features. Exemplary sensors applicable to the present disclosure include one or more of a GPS unit, a radio detection and ranging (radar) unit, a light detection and ranging (LIDAR) unit, an ultrasonic sensor, an infrared sensor, an inductance sensor, a camera, an accelerometer, a tachometer, a temperature sensor, a pressure sensor, and a speedometer. Some of the sensors (e.g., radar, LIDAR, or camera units) may actively or passively scan the vehicle environment for obstacles (e.g., other vehicles, buildings, pedestrians, etc.), roadways, lane markings, signs, or signals. Other sensors (e.g., GPS, accelerometer, or tachometer units) may provide data for determining the location or movement of the vehicle (e.g., via GPS coordinates, dead reckoning, wireless signal triangulation, etc.). In aspects, particular sensors may provide data on temperature of contents in a fuel tank (e.g., hydrogen and/or hydrogen vapor), pressure inside a fuel tank (e, g., hydrogen tank), and the like.

As discussed, cooling system 270 is operable to substantially reduce, or eliminate completely, release of vaporized cryogen (e.g., hydrogen) to the atmosphere. The cooling system can be selectively controlled to impart cooling to the cryogenic tank 100 via reliance on the catalyst and heat exchanger assembly 108 and/or chiller 106. Control strategy may rely on just the catalyst and heat exchanger assembly 108 for some cooling operations, just the chiller 106 for some cooling operations, or some combination of both for particular cooling operations. The combination need not necessarily occur simultaneously for a particular cooling operation, and in aspects a cooling operation may additionally or alternatively involve controlling whether gaseous hydrogen is rerouted to the tank 100 or not, as discussed with regard to FIG. 1B using system 145. When referring to tank 100, in some aspects system 145 is included as a part of tank 100. For example, the chiller 106 may be used at a same time as ullage gas is being drawn through the catalyst and heat exchanger assembly 108, or at a time when ullage gas is not being drawn through catalyst and heat exchanger assembly 108. In aspects, a bypass circuit 206 may be present in cryogenic tank 100.

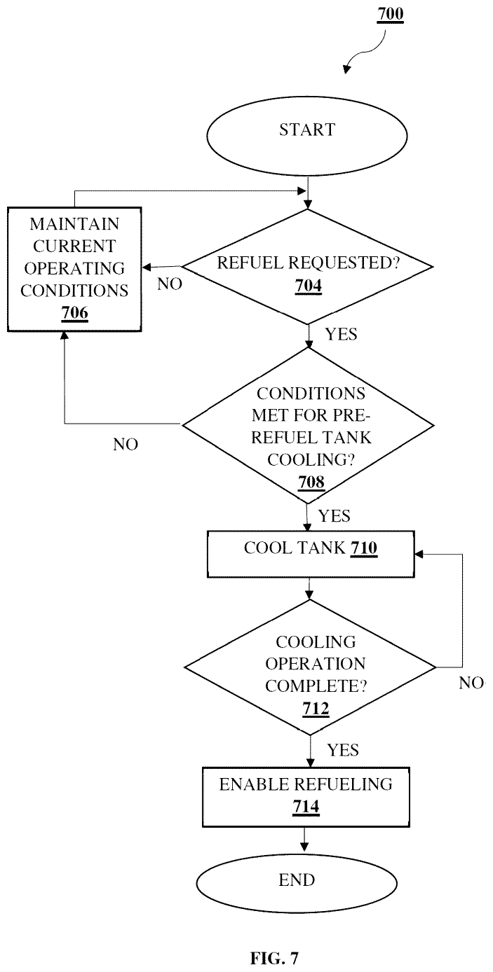

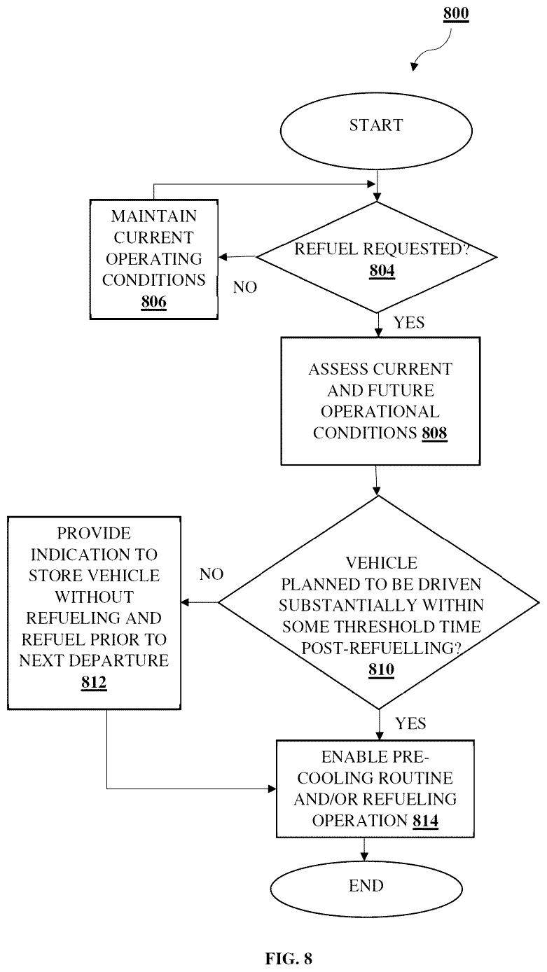

As discussed, the actuator(s) 218 that control various aspects of the cryogenic tank's cooling system 270 can be controlled based on input received from one or more sensors 216 and/or via operator commanded control. For example, a vehicle Global Positioning System (GPS) 222 can provide relevant inputs to the controller 212, such that tank cooling is effectively managed by control strategy. For example, GPS 222 may be used by predictive route module 234 to infer or predict upcoming fuel filling stations, and said information may be used by the controller 212 to control various aspects of the cooling system 270 and/or aspects of system 145 at FIG. 1B, accordingly. Such an example is described in more detail below particularly using FIGS. 7 and 8.

The vehicle 250 as shown at FIG. 2 and including the systems shown therein and including those discussed at FIGS. 1A-1B, enables a number of methods that can be used to ensure that hydrogen is not wasted (e.g., released in significant amounts to atmosphere in order to prevent tank overpressure conditions), which is advantageous because 1) hydrogen as a fuel is costly and 2) release of hydrogen to atmosphere can contribute to climate change. It is desirable that any actions taken to reduce the wasting of hydrogen also use as little energy as reasonably possible, or in other words optimize energy usage allocated to conducting cooling operations of the tank 100. In this way, release of hydrogen to atmosphere is substantially reduced or eliminated while minimizing energy usage in an effort to do so.

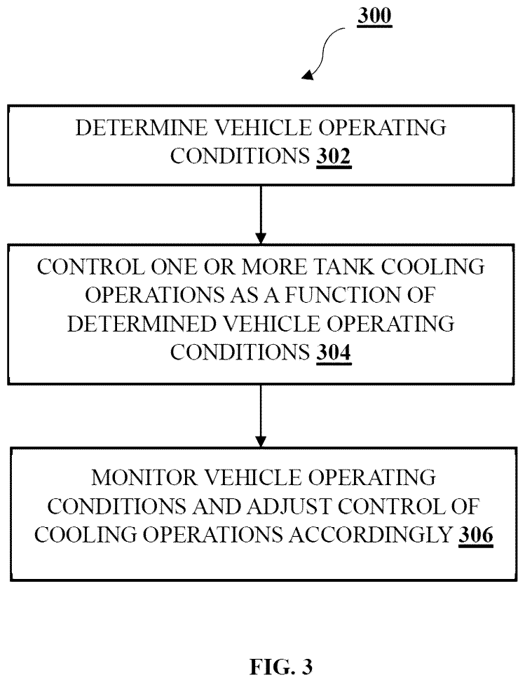

Turning to FIG. 3, depicted is a high-level flowchart for a method of operating the disclosed systems. Method 300 will be described with reference to the systems described herein and shown in FIGS. 1A, 1B and 2, though it should be understood that similar methods may be applied to other systems without departing from the scope of this disclosure. Instructions for carrying out method 300 and the rest of the methods included herein may be executed by a controller of the control system, such as the control system 214 of FIG. 2, based on instructions stored in non-transitory memory and in conjunction with signals received from sensors of the system, such as the pressure sensors 136, temperature sensors 132. GPS 222, and so on. The controller may employ actuators of the disclosed systems to control cooling operations of the cryogenic tank 100, according to method 300 and those further described below.

Beginning at step 302, method 300 includes determining operating conditions based on data received from one or more sensors of a vehicle, wherein the vehicle comprises a cryogenic tank and wherein the cryogenic tank is configured to hold a cryogenic fluid and an ullage gas in an ullage space of the cryogenic tank. Operating conditions can include but are not limited to level of fuel in the fuel tank (e.g. tank 100 at FIGS. 1A-1B), pressure in the fuel tank, temperature in the fuel tank, presence or absence of a request to refuel, proximity to refueling stations, current and predicted upcoming terrain the vehicle is traveling along (e.g., uphill stretches, downhill stretches, etc.), external conditions such as weather conditions including ambient temperature, atmospheric pressure, and humidity, and so on. Proceeding to step 304, method 300 includes, via a controller (e.g., controller 212), controlling operational aspects of the cooling system (e.g., cooling system 270 at FIG. 2) and/or system 145 at FIG. 1B, based on the retrieved vehicle operating conditions. As an example, controlling operational aspects of the cooling system at step 304 can include sending a signal or signals to one or more actuators configured to control operation of chiller 106 and/or which control the flow of cryogenic fluid (e.g., ullage gas) across the para-ortho catalyst 105 to impart a cooling effect in the tank and/or cryogen, and/or controlling whether gaseous hydrogen is reintroduced to the tank, or not, via the system 145 shown at FIG. 1B, to control pressure in the tank. Once initiated, method 300 proceeds to step 306. At step 306, method 300 includes monitoring vehicle operating conditions and adjusting control of any ongoing cooling operations as a function of the monitored vehicle operating conditions. For example, monitoring vehicle operating conditions may include receiving information from one or more sensors as herein described. Adjusting control of cooling operations accordingly can include, for example, sending a signal or signals to the one or more actuators configured to control operation of chiller 106 and/or control the flow of cryogenic fluid (e.g., ullage gas) across the para-ortho catalyst 105 to impart a cooling effect in the tank and/or cryogen, and/or controlling whether gaseous hydrogen is reintroduced to the tank, or not, via the system 145 shown at FIG. 1B, to control pressure in the tank. Adjusting control of cooling operations can include, when conditions are met for doing so, discontinuing a particular cooling operation. In this way, the systems of the present disclosure enable the fine control over one or more of fuel tank pressure and temperature, which in turn can improve operational aspects of vehicle use and reduce or eliminate release of hydrogen to atmosphere. In some examples, as will be discussed in more detail below, cooling operations are conducted in order to facilitate improved refueling operations with the goal of reducing or eliminating release of hydrogen to atmosphere.

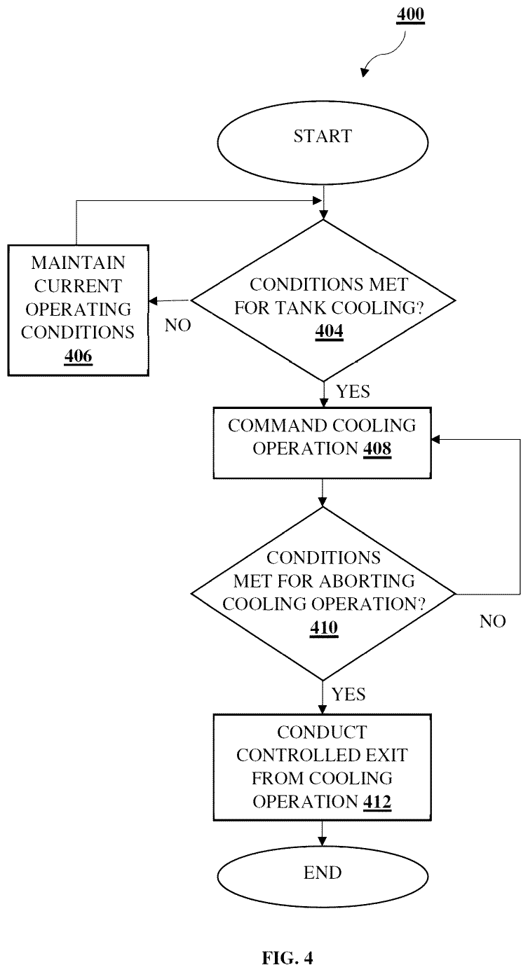

Turning now to FIG. 4, depicted is a high-level flow diagram for conducting a cooling operation of the cryogenic tank according to an aspect. The method 400 begins at step 404 and determines whether conditions are met for conducting a cooling of cryogenic tank 100. Said conditions being met may include one or more of i) the vehicle is being driven and consuming hydrogen gas, ii) the vehicle is parked and connected to external power supply for powering the chiller 106, iii) fuel fill level is below some predetermined threshold level, iv) fuel fill level is above some predetermined threshold level, for example, predetermined threshold level could be 1/10^{th} to ¼^{th} and above ¼^{th} of the capacity of the tank, v) tank pressure is above some predetermined threshold level, where pressure limits may be based on the tank stress and/or strain design limits with safety factors consideration, vi) tank temperature is above some predetermined threshold level, where threshold levels for temperature could be based on limiting an evaporation rate of the cryogen, vii) weather conditions (e.g., ambient temperature, ambient pressure, humidity levels, etc.) are such that tank cooling is advantageous, viii) route conditions, for example, the vehicle is traveling or is predicted to travel uphill for more than some predetermined time or distance within some threshold timeframe, for example, predetermined time may be in a range of 1 minute to 5 minutes or greater than 5 minutes, ix) the vehicle is traveling or is predicted to travel on a road that could lead to significant fuel slosh that may increase pressure and/or temperature in the tank, where a rate of increase in pressure or temperature is above a rate threshold, for example rate of increase of pressure threshold greater than 10 pascals per square inch per minute and above or rate of increase of temperature is 3 degrees centigrade per minute and above, x) tank refueling has been requested via vehicle controls or a vehicle operator, and/or xi) the vehicle is determined to be within a threshold proximity to a fuel filling station and fuel level is below some threshold level, where threshold proximity to a fuel filling station could be in a range of 0.1 miles to 1 mile, 1 mile to 2 miles, 2 miles to 3 miles, or within 5 miles, and fuel level below a threshold level could be ¼^{th} to 1/10^{th} of the tank level or below 1/10^{th} level of the tank, etc.

If conditions are not indicated to be met for tank cooling at 404, method 400 proceeds to step 406, where current operating conditions are maintained. For example, the chiller 106 may remain off, and ullage gas may be directed to be routed through bypass circuit comprising a bypass conduit 126 and a valve 128. Furthermore, gaseous hydrogen may continue to be circulated back to tank 100 as discussed above with regard to FIG. 1B, to warm the tank and in turn generate additional vaporization for continued consumption by the hydrogen consumer (e.g., fuel cell).

Responsive to conditions being indicated to be met for tank cooling at step 404, method 400 proceeds to step 408. At 408, a cooling operation is commanded. In some examples, the cooling operation comprises directing ullage gas to be routed to outlet/inlet 110 via the catalyst and heat exchanger assembly 108. In some examples, the cooling operation comprises commanding the chiller 106 to operate to cool the tank and tank contents. In some examples, the cooling operation comprises stopping the recirculation of warmed gaseous hydrogen back to the tank (e.g., valve 158 closed and valve 162 opened), which in turn results in tank cooling due to the lack of additional warming, along with preventing further increases in fuel tank pressure.

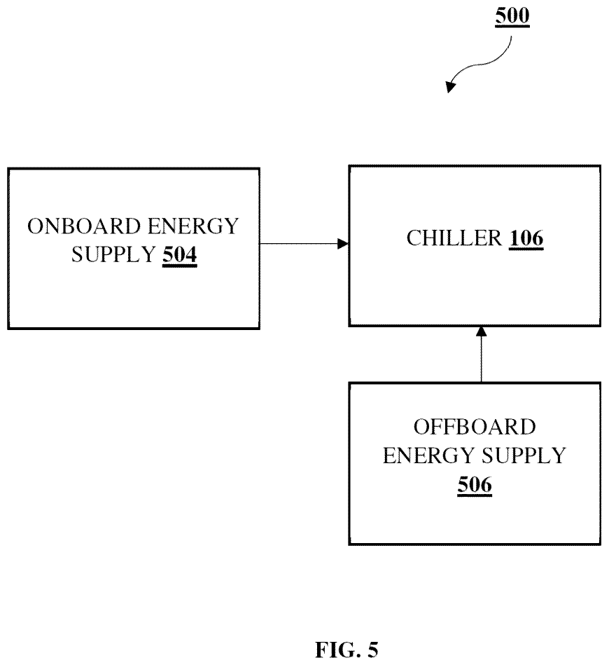

In some examples, commanding the cooling operation at step 408 includes selecting a source of power supply to power the chiller 106. Briefly, the chiller 106 relies on a power source to operate. The power source may be an onboard power source, for example the high voltage battery shown as energy storage device 232 in FIG. 2, or the power source may be an external power source, also referred to herein as “shore power”. Turning briefly to FIG. 5, shown is a chiller power supply system 500. System 500 includes chiller 106, along with potential power sources for powering the chiller. Chiller 106 may be powered by an onboard energy supply 504, under some conditions. For example, when the vehicle is in operation being propelled, chiller 106 relies on an onboard energy source which could be a primary fuel cell, a secondary fuel cell, a high voltage traction battery, an auxiliary battery, or some combination. For example, the fuel cell may be operated to store energy in a battery (e.g., high voltage (HV) traction battery), and in turn the battery may supply power to the chiller 106.

Alternatively, chiller 106 may be powered via offboard energy supply 506. Offboard energy supply 506 may be some sort of battery (e.g., charger) that the vehicle can be plugged into, which is capable to supply power to chiller 106.

There may be operating conditions which result in the use of one power source over another. For example, powering the chiller via onboard energy may be a function of onboard energy availability. Hydrogen for use in propelling the vehicle is costly and hence there is a tradeoff in relying on hydrogen for energy production that, in turn, is used for powering chiller 106. In certain circumstances, e.g., tank pressure above some threshold tank pressure, battery state of charge (SOC) above some threshold SOC, fuel level above some threshold fuel level, control strategy may determine that onboard energy can be used to power chiller 106. Alternatively, in other examples including battery SOC below a threshold and/or fuel level below some threshold, amongst others, vehicle control strategy may determine that it is not an effective use of energy to power chiller 106 with onboard energy supply. Conditions disfavoring the use of onboard energy supply may alternately favor the reliance on offboard energy supply to power chiller 106. The chiller 106 may be prioritized to be powered using external power or offboard energy supply 506 when the vehicle is plugged into an external power source and/or when the vehicle is parked for prolonged hours. Offboard energy supply may include one of grid power, charging station, portable generator, etc. Generally speaking, chiller power supply system 500 prioritizes the use of external power/offboard energy supply 506 to power the chiller as much as possible so that energy is not wasted in using hydrogen or onboard power sources to power the chiller.

In one or more aspects, a vehicle as disclosed herein may comprise a dual fuel cell configuration, i.e., a primary fuel cell and a secondary fuel cell. The primary fuel cell may serve as the main power source for the vehicle, providing the bulk of the energy needed for propulsion, onboard systems, and other power demands while the secondary fuel cell may act as a backup power source either in case of failure of primary fuel cell or to provide additional power during acceleration, step climb, heavy loads, etc. In one or more aspects, a primary fuel cell powers the vehicle to drive, but a secondary fuel cell may also be present on the vehicle, for example, heavy duty trucks, long haul trucks, etc. In aspects, the primary fuel cell powers the chiller. In aspects, the secondary fuel cell powers the chiller. In aspects, control logic may select whether to use a primary or a secondary fuel cell for chiller power supply.

Accordingly, returning to step 408 of method 400, commanding the cooling operation may include selecting how to conduct the cooling operation, for example, whether to impart tank cooling via catalyst and heat exchanger assembly 108, via chiller 106, or via stopping recirculation of warmed hydrogen gas back to the tank, or some combination of these. Commanding the cooling operation at 408 may additionally include selecting a power source to use to power the chiller 106, under conditions where it is determined that the chiller 106 should be used to conduct the cooling.

Proceeding to 410, method 400 continuously monitors the conditions to determine if conditions are met for aborting the cooling operation. Conditions that are checked to determine if they are met or not to exit a cooling operation include, for example, whether tank temperature has dropped below a threshold, tank pressure has dropped below a threshold, cooling operation time limit has expired, onboard energy storage and/or fuel level has dropped below some threshold values, whether a fueling station has been reached, etc. If conditions are not met at step 410, method 400 continues the cooling operation at step 408. Responsive to conditions being met at 410, method 400 proceeds to conduct a controlled exit from the cooling operation at step 412 and method 400 ends.

Broadly speaking, while the vehicle is in operation and is consuming cryogen (e.g., hydrogen), default may be to draw ullage gas through the catalyst and heat exchanger assembly 108, so that some level of cooling is happening during normal course of vehicle operation. There are circumstances, however, when cooling in this manner may not be desired. For example, cooling reduces vaporization of hydrogen in the tank, and gaseous hydrogen is what is relied on by the consumer (e.g., fuel cell or hydrogen-internal combustion engine (H₂-ICE)). Accordingly, under circumstances of high load where the consumer is requesting substantial quantities of gaseous hydrogen, cooling may not be desirable. With reference to method 400, in an example where the default mode is to rely on drawing ullage gas by way of the catalyst and heat exchanger, the methodology may continually assess whether conditions are met for additional cooling according to the logic set forth at FIG. 4.

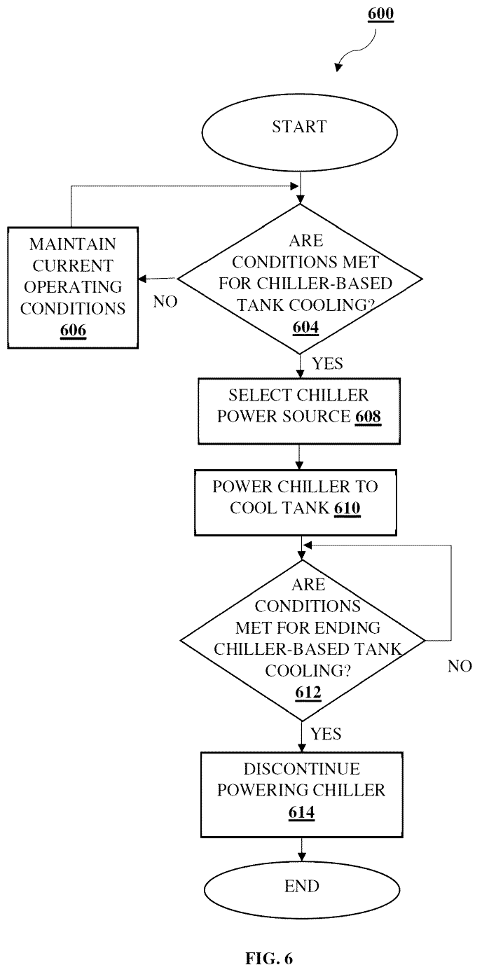

Turning now to FIG. 6, shown is a high-level flow diagram for a method 600 for conducting a cooling operation of the cryogenic tank, according to an aspect.

Method 600 begins at step 604 and includes determining whether conditions are met for conducting a tank cooling operation via chiller 106. Specifically, method 600 pertains to determining when and how to conduct a cooling operation via chiller 106, based on when the vehicle will be parked, or is parked, for some extended period of time. The objective of method 600 is to prevent an increase in ullage gas (i.e., the vaporization of hydrogen in the tank) while the vehicle is parked, that may result in a need to vent the tank (e.g., tank 100) to atmosphere. For example, hydrogen in a fuel tank of a parked vehicle may vaporize due to vehicle and/or environmental conditions. Depending on the level of fuel in the tank, such vaporization may lead to an overpressure condition where the tank needs to be vented to prevent degradation of the tank. As discussed, an objective of this disclosure is the prevention of release of hydrogen to atmosphere. Method 600 controls cooling during parking conditions such that release of hydrogen to atmosphere is substantially reduced as compared to similar vehicles that do not include methodology of FIG. 6, or avoided altogether.

Method 600 begins at 604 and includes determining whether conditions are met for chiller-based cooling. Conditions being met at 604 include but are not limited to the vehicle being parked (or predicted to be parked) for at least some threshold time (e.g., greater than 10 minutes, 20 minutes, 40 minutes, 1 hour, 2 hours, or more than 2 hours), the vehicle being coupled to an external power supply (e.g., connected to shore power), fuel level above some threshold where tank over-pressurization is likely or predicted to occur, ambient temperature above some predetermined threshold temperature, humidity above some predetermined threshold humidity, fuel tank pressure above a fuel tank pressure threshold, fuel tank temperature above a fuel tank temperature threshold, etc.

If, at 604, conditions are not met for chiller-based tank cooling, method 600 proceeds to step 606 where current operating conditions are maintained and the chiller is maintained inactive. Alternatively, responsive to conditions being met at 604, method 600 proceeds to step 608. At step 608, method 600 includes selecting a power source for powering chiller 106. As discussed, the chiller 106 may be powered using an onboard energy supply, or an offboard energy supply. When the vehicle is parked and plugged into an external energy supply (e.g., shore power), method 600 prioritizes the reliance on the use of the external energy supply. If parked and not coupled to an external power supply, onboard energy supply may be used. However, for conditions to be met for conducting a cooling operation using the chiller when the vehicle is parked and not connected to an offboard energy supply, then another set of specific conditions needs be met. Specifically, at least battery SOC needs to be greater than some predetermined threshold and/or cryogenic fuel level above a certain threshold. This SOC threshold may vary depending on a predicted or otherwise inferred/determined amount of time the vehicle is to remain parked. For example, the amount of time the vehicle is to remain parked may be determined based on a fleet schedule, a manual input via a vehicle operator through a human machine interface (HMI) in the vehicle or a device (e.g., smartphone, tablet, computer) communicatively coupled to the vehicle, a learned amount of time for a particular stop based on, e.g., one or more of day of week/month, time of day, location, particular vehicle, etc.

With the chiller power source selected at 608, method 600 proceeds to step 610. At 610, method 600 includes providing power to chiller 106. An amount of power requested by the chiller (or amount of power determined appropriate via the controller relying on control logic) may be a function of an amount of cooling action desired, and may be based on one or more conditions such as fuel tank fill level, ambient temperature, ambient humidity, tank pressure, tank temperature, etc.

With the chiller 106 powered, method 600 proceeds to 612. At step 612, method 600 includes assessing whether conditions are met for ending the chiller-based cooling operation. Conditions being met for ending the cooling routine may include fuel tank pressure and/or temperature dropping below predetermined thresholds, ambient temperature dropping below some temperature where vaporization is predicted to occur at a rate that does not lead to an overpressure condition, expiration of a timer associated with the cooling operation, a request to operate the vehicle (e.g., vehicle startup), etc.

If, at 612, it is determined that conditions are not met for ending chiller-based tank cooling according to method 600, method 600 continues to request power from the selected power source and the chiller remains powered. Alternatively, responsive to conditions no longer being met for chiller-based cooling, method 600 proceeds to step 614, where the powering of the chiller is discontinued.

In an example scenario where the vehicle is parked for a prolonged time period (e.g., greater than 1 hour or overnight), method 600 may repeatedly initiate and complete/end in order to preserve energy. Advantageously, cycling the powering of the chiller may reduce an overall amount of energy required over time to maintain the tank 100 such that venting of the tank to atmosphere is not needed. As a prophetic example, the chiller may initially be powered for some amount of time, until conditions are no longer met for powering the chiller. For example, a timer may expire, fuel tank temperature and/or pressure may drop below some threshold, and so on. Following the stoppage of powering the chiller 106, conditions may again become met for powering the chiller 106. At this point, method 600 may again initiate control strategy to power the chiller and control fuel tank conditions. In this way, even on extended parking events, the fuel tank conditions may be controlled in a manner that avoids the need to vent the tank to atmosphere. In aspects, the controller of the vehicle may be awakened from a sleep mode periodically, for example, according to a schedule stored at a lookup table on the vehicle, in order to check if conditions are met for chiller-based tank cooling. In aspects, the intervals between controller wake events from a sleep state may be a function of one or more conditions which may affect conditions in the fuel tank. For example, in higher ambient temperatures, the controller may wake more often (i.e., shortened intervals between controller wake events) as compared to cooler climates. This may correlate with time of day, where ambient temperature tends to cool at night. Accordingly, sleep/wake cycles may be a function of ambient temperature, time of day, amount of shading (e.g., vehicle is inside or outside, beneath a tree or tent, etc.), humidity, elevation, road surface (e.g., heat transfer to fuel tank may be greater on asphalt than another material), and any other condition that may impact fuel tank conditions which may necessitate chiller activation to control tank pressure and/or temperature with the goal of reducing or avoiding altogether release of hydrogen to atmosphere in order to relieve the tank of excess pressure and/or to cool the tank contents.

Turning now to FIG. 7, shown is a high-level flowchart for method 700. Method 700 may be used to pre-condition the fuel tank 100 for an upcoming refueling event, by relying on the disclosed systems (e.g., cooling system 270, system 145), and control thereof, in order to do so.

Method 700 begins at 704 and includes indicating whether a refueling event is requested. The indication may be from a human operator driving the vehicle, in aspects. For example, a human operator may interact with a refueling button in the cabin of the vehicle, or via an HMI, to indicate an upcoming request to refuel. In aspects, the request may originate from control strategy in lieu of a vehicle operator, whether or not there is a vehicle operator controlling the vehicle. For example, upon detecting a fuel level below some predetermined refueling threshold, a request for refueling may be initiated by the controller. The controller may monitor the fuel level in the fuel tank, and when fuel level drops below the refueling threshold, the request is initiated. When a vehicle operator is in the vehicle, the request may be communicated (e.g., audibly or via another means such as HMI in the cab) to the vehicle operator. However, in aspects the vehicle may be an autonomous vehicle capable of being driven without a human operator, and in such a case the logic described may still occur.

In aspects, a refueling request can stem from data corresponding to a predictive route module stored at the controller. For example, the predictive route module 234 may be configured so as to receive current vehicle location updates, for example via the GPS 222 or otherwise (e.g., smart device communicatively coupled to the controller 212) and use such information to control one or more actuators in the vehicle based thereon. In aspects, the controller in conjunction with the predictive route module may be configured to determine relative proximity to relevant objects including, for example, refueling stations capable to refuel the tank 100. In aspects, the vehicle operator, or fleet manager, may pre-select particular fuel filling stations that are preferred, or may rank particular fuel stations from ideal choices to non-ideal choices, and therebetween. Rankings may be based on price, proximity to typical routes, level of attendance (e.g., how busy, for example as a function of time of day), and so on.

In aspects, when the vehicle has a predictive route module activated, fuel level dropping below some threshold may cause the controller to search for nearby refueling stations as a function of the level of fuel in the tank and based on any other parameters including but not limited to vehicle operator or fleet operator preferences, as discussed above. Responsive to identifying a refueling station that satisfies the requisite criteria, the vehicle operator may be notified of the request to drive the vehicle to the selected refueling station. The notification may be in the form of an audible indication, a message displayed e.g., via HMI in the vehicle dash, or any other manner (e.g., text message to selected device). In the case of a fully autonomous vehicle with the predictive route module activated, control strategy may simply determine the most appropriate refueling station to travel to and may control one or more actuators such that the vehicle updates its route in order to arrive at the refueling station without running out of fuel prior.

In aspects, the predictive route module may know far in advance approximately when fuel is expected to run low along a particular delivery route, and the route the vehicle travels on may include select refueling stations along the way, such that the trigger for heading to a refueling station need not be fuel level dropping below a threshold specifically, but rather fuel consumption may be accounted for as a function of travel route in order to guide the vehicle to appropriate refueling stations along particular travel routines.

If, at step 704, it is determined that refueling is not requested, then current vehicle operating conditions may be maintained at step 706. For example, a pre-refueling tank cooling operation may not be initiated.

Alternatively, responsive to refueling being requested at step 704, method 700 proceeds to step 708. At 708, method 700 determines whether conditions are met for conducting a pre-refuel tank cooling operation. Conditions being met at 708 may include one or more of pressure in the fuel tank above a threshold refueling pressure, temperature in the fuel tank being above a threshold refueling temperature, fuel level in the tank above some threshold (or below some threshold), battery SOC being above some threshold refueling SOC, proximity to refueling station below some refueling distance threshold, ambient temperature above a threshold, and so on. In some examples where the predictive route module is active, the controller may determine when conditions are met for activating pre-refuel tank cooling, however in other additional or alternative examples, a vehicle operator may specifically request a pre-refuel cooling operation (e.g., via HMI or other manner).

In some aspects, conditions being met for pre-refuel tank cooling at 708 include an indication that the vehicle will be driven within some predetermined timeframe post refueling. In aspects, the predetermined timeframe is less than one hour, for example between 1 minute and 1 hour, for example within 1-10 minutes, 10-20 minutes, 20-30 minutes, or between 30 minutes and an hour. If the vehicle is not planned to be driven within the predetermined timeframe, then alternative strategy may be selected, which will be discussed in more detail below. Importantly, in aspects, conditions being met for pre-refuel tank cooling also includes an indication that the vehicle will be significantly driven post-refueling, not just driven a mile or two and then parked for an extended period of time (e.g., overnight). For example, conditions being met at 708 may include an indication that the vehicle will be driven within some predetermined time period post-refueling, and also that the vehicle will be driven for one or more of some threshold amount of time (e.g., greater than 1, 2, 3, 4, 5 hours with only short interval stops of about 5-30 minutes), driven such that at least a threshold amount of fuel will be used (e.g., from 1/10^{th} to ¼ tank), etc. Again, if the vehicle will not be driven substantially following the refueling, another strategy can be pursued, discussed in greater detail below.

In some aspects, conditions being met for pre-refuel tank cooling include an indication that the refueling station the vehicle is planning to travel to has power supply capabilities (e.g., shore power available). In some examples, the pre-refuel tank cooling can be conducted when the vehicle is stopped and hooked up to an offboard power supply. However, as discussed above, in aspects, cooling operations can be conducted by relying at least in part on onboard sources of energy (e.g., battery).

Provided that conditions are indicated to be met for conducting a pre-refuel tank cooling operation, method 700 proceeds to step 710. At 710, the pre-refuel tank cooling operation is initiated. It is herein recognized that refueling a cryogenic tank with liquid hydrogen is substantially more efficient when the tank and its contents are at lower temperature and pressure. The lower the temperature of the tank and its contents, the greater the amount of liquid cryogen that can be added. The more fuel that can be added, the longer the vehicle can travel before refueling is needed, a strong advantage for delivery trucks on a schedule.

Conducting the pre-refuel tank cooling can include one or more of the following. First, the consumer (e.g., fuel cell) may be controlled to request gaseous hydrogen in a manner that draws ullage gas across the catalyst and heat exchanger assembly 108. In this way, cooling may be imparted to the tank and its contents, in the manner described above. Second, the system 145 may be controlled in a manner that prevents warmed hydrogen from being reintroduced to the tank for purposes of increasing vaporization. Specifically, gaseous hydrogen may be prevented (e.g., valve 158 maintained closed) from being routed back to the tank along conduit 150, instead being routed to the consumer (e.g., fuel cell) without any additional heating supplied to the tank. If the circuit were not modified to prevent the warmed hydrogen from being reintroduced to the tank by way of conduit 150, then the warming effect could counter the cooling effect in a manner that renders the cooling efforts less effective. Third, in certain conditions chiller 106 may be activated by the controller 212 to further cool the interior of the tank and its contents. Whether to activate the chiller 106 during the act of driving to the refueling station may be dependent on vehicle operating conditions and, in aspects, tank conditions (e.g., tank pressure, temperature, fuel level). As discussed above, operating the chiller 106 requires power, and when the vehicle is operating, the power must come from onboard energy stores. Accordingly, in determining whether to activate the chiller 106 as part of the pre-refuel cooling operation, controller 212 may assess one or more of battery SOC, fuel level in the fuel tank, tank conditions such as temperature and pressure, ambient conditions (temperature, pressure, humidity), etc. Any use of the chiller 106 to cool the tank is weighed against the advantages and disadvantages of doing so. In other words, if the energy gained in the form of, e.g., increased capability to add fuel to the tank, outweighs the amount of energy used by the pre-refuel operation, then it may make sense to rely on onboard energy to cool the tank via chiller 106. In one example, the fuel cell may operate at some higher load in order to divert some energy usage towards charging the battery (e.g., high voltage battery). In this way, cryogen can be used to supplement battery storage, and then the battery can be relied upon for powering the chiller. In some examples, a secondary fuel cell can be relied upon directly for powering chiller 106. In still further examples, a primary fuel cell (e.g., primary for vehicle propulsion) may be relied upon directly for powering the chiller 106.

In some examples, the cooling operation need not all be conducted while the vehicle is traveling across land to the refueling station. In aspects, a portion of the tank cooling may be conducted while the vehicle is traveling, and another portion can be conducted once the vehicle has stopped at the refueling station. For example, the control strategy may determine to keep the chiller unpowered while the vehicle is traveling and rely on the catalyst and heat exchanger assembly 108, in combination with stopping the reintroduction of warmed hydrogen into the fuel tank to increase vaporization of fuel (refer to FIG. 1B). Then, when the vehicle is stopped at the refueling station, the control strategy may assess whether the vehicle has been hooked up to receive power from an offboard source. Responsive to an indication that the vehicle is capable to receive offboard power to supply to chiller 106, the chiller may be activated, and the cooling operation may continue. In the case where the vehicle includes a human operator, the details of the cooling operation, including relevant instructions (e.g., reminder to hook up to shore power prior to refueling) can be communicated to the vehicle operator via HMI or otherwise (e.g., audibly). When hooked into shore power, the tank and its contents may be cooled, and such cooling may be monitored (e.g., by temperature and/or pressure sensor(s) included as part of the tank). An indication may be provided once the tank has been cooled to a predetermined level of cooling. In the case of an autonomous vehicle (not necessarily including a human operator), various steps for conducting the pre-refuel tank cooling may be controlled in lieu of any vehicle operator intervention/manipulation.

With the cooling operation initiated at 710, method 700 proceeds to step 712. At 712, method 700 includes determining whether the cooling operation is complete. The cooling operation may be complete if certain parameters of the cooling operation are fulfilled. For example, tank pressure and/or temperature reaching respective thresholds may indicate that the cooling operation is complete. In additional or alternative examples, the cooling operation may be conducted for some predetermined amount of time which, when reached, may signal the end of the cooling operation. In additional or alternative examples, the cooling operation may monitor a rate of change of pressure and/or temperature in the fuel tank, and the cooling operation may be indicated to be complete once pressure and/or temperature has changed at a certain rate or higher, for more than some threshold period of time.

Responsive to the cooling operation being indicated to be complete, method 700 proceeds to step 714, where refueling is enabled. In aspects, enabling refueling may include granting access of the fuel tank to the vehicle operator or fuel station attendee. Granting access may include opening an otherwise locked fuel filler door, and the like.

Although not specifically elaborated upon in the discussion of FIG. 7, it is herein recognized that in some aspects, the chiller 106 can remain powered during the refueling event. For example, having the chiller powered can contribute to further cooling during the refueling process itself, which may in turn increase the efficiency of the refueling operation (e.g., more liquid hydrogen can be added). In aspects, control strategy maintains the chiller 106 on, when hooked up to shore power during a refueling event.

Turning now to FIG. 8, shown is a high-level flowchart for an example method 800, which can be used to control pre-refuel tank cooling operations as a function of current and future vehicle operational conditions. Specifically, method 800 may be used to selectively conduct pre-refuel tank cooling operations in a manner that avoids filling a fuel tank with cryogen (e.g., hydrogen) if extended vehicle down-time is scheduled or otherwise predicted within some short timeframe post refueling. Advantageously, by avoiding filling the tank with cryogen and then having the vehicle sit in a nonoperational state, where vaporization of the cryogen and corresponding increases in tank temperature and pressure then occur, the need to vent the tank to atmosphere may be reduced or eliminated altogether.

Method 800 begins at 804 and includes indicating whether refueling is requested. Determining whether refueling is requested at step 804 occurs substantially similar to that discussed with regard to step 704 at method 700. If refueling is not requested, current vehicle operating conditions are maintained and the specific cooling operation pre-refueling is not initiated.

Alternatively, responsive to an indication that refueling is requested at 804, method 800 proceeds to step 808. If refueling is not requested at 804, method 800 proceeds to step 806 and maintains the current operating conditions. At step 808, method 800 assesses current and future operational conditions. For example, controller 212 may retrieve information pertaining to vehicle operational schedule (e.g., as part of a fleet schedule, a route input by the driver into GPS 222 or other HMI, etc.).

Proceeding to step 810, method 800 includes determining, based on the retrieved current and future operational conditions, whether the vehicle is planned to be driven substantially within some threshold time post-refueling. As mentioned with regards to method 700 at FIG. 7, the threshold time may be less than one hour, for example between 1 minute and 1 hour, for example within 1-10 minutes, 10-20 minutes, 20-30 minutes, or between 30 minutes and an hour. In some aspects, the threshold time may be greater, for example between one hour and four hours. “Driven substantially”, in the context of method 800, refers to operating the vehicle such that a threshold amount of fuel will be consumed prior to the vehicle being parked for some extended period of time, or refueled. As mentioned above at FIG. 7, substantial driving may include driving and using fuel in the tank for at least 30 minutes, one hour, two hours, three hours, four hours, or more, for example five hours or more. Additionally or alternatively, substantial driving may include driving in a manner where at least a threshold amount of fuel is expected to be used (e.g., from 1/10^{th} to ¼ tank).

If, at 810, the vehicle is not planned to be driven substantially within the threshold time post-refueling, then method 800 proceeds to 812. At step 812, method 800 includes providing an indication to store the vehicle without refueling, and to refuel the tank following the storing, just before departure where the vehicle will be driven substantially essentially immediately following the refueling.

As one example, such an indication may be provided to an operator of the vehicle audibly or visibly, for example via the vehicle sound system or HMI, respectively. The indication may include a brief explanation as to the reasoning behind postponing the refueling and hence, any associated pre-refuel tank cooling operations for the time being. For example, the indication may include some reference to the fact that, if the tank were refueled and then let sit overnight, a not-insignificant amount of fuel may need to be released to atmosphere in order to ensure fuel tank overpressure conditions do not occur. Of course, this is not only a waste of fuel but also is not desirable from an environmental perspective.

In the case of an autonomous vehicle that lacks a human operator, control strategy may simply control the vehicle in a manner according to the methodology of FIG. 8, where the vehicle will be maneuvered to a stop without refueling if method 800 indicates that the most advantageous sequence of pre-refuel tank cooling and subsequent refueling includes postponing the refueling until just before the vehicle will be driven substantially once again.

While not explicitly illustrated, it is to be understood that it is advantageous to provide power supply for chiller 106, even if the refueling is postponed, where reasonably possible. However, even in the event that chiller power is not available, method 800 strives to reduce fuel tank pressure and/or temperature and/or fuel fill level such that opportunity for release of hydrogen to environment is purposefully limited. For example, if postponing a refueling event to store the vehicle with less fuel in the tank, hence less opportunity for a tank overpressure condition that could necessitate tank venting to atmosphere, in an aspect, control strategy may strive to operate the hydrogen consumer (e.g., fuel cell) in a manner that reduces fuel volume as much as possible before the stop and stores the additional energy as battery charge. In this way, the vehicle may reduce its overall level of cryogen in the tank just prior to the vehicle sitting for some time, and also can increase the SOC on the battery, such that the battery can be relied upon, while the vehicle is being stored, to power the chiller in the event that control strategy deems a cooling operation necessary to prevent hydrogen release to environment. Even if the vehicle is capable of being hooked up to shore power (e.g., shore power options are available), it may still be desirable to store the energy from fuel as charge in the battery given the likelihood that at least a portion of that fuel may contribute to tank conditions that necessitate venting to atmosphere.

In some aspects, a cooling operation can be conducted just before parking the vehicle to store it until the next departure, although not specifically shown. Any one or more of the catalyst and heat exchanger assembly 108, chiller 106, and/or system 145 can be used in the manner discussed to cool the tank just prior to storing, to bias the tank towards low tank pressure and temperature conditions, thereby making it less likely for tank overpressure condition(s) to occur while the vehicle is parked.

If it is determined that the vehicle is predicted or planned to be driven substantially within the threshold time post-refueling, or if not, at step 814 method 800 includes conducting the pre-refueling tank cooling operation at the appropriate time. For example, responsive to being stored/parked for the extended time period, once it is time to refuel (e.g., within some timeframe starting from when the vehicle is subsequently driven/operated), control strategy may initiate the pre-refueling cooling operation in substantially similar fashion as discussed above. Similarly, if the vehicle is currently being driven enroute to a fuel filling station, where the vehicle is planned/predicted to be driven substantially essentially immediately following refueling, then the pre-refueling tank cooling operation is conducted at step 814. Again, the pre-refueling tank cooling operation can be conducted in substantially similar fashion as that discussed above with regards to FIG. 7. Once the controller deems the pre-refueling tank cooling operation is complete, method 800 may enable refueling to commence, and then end.

Although not elaborated upon in great detail with regard to the method of FIGS. 7-8, it is to be understood that, in aspects, pre-refuel tank cooling operations can be at least initiated by a vehicle operator. For example, circumstances may be such that route prediction technology is not operating in the vehicle due to a fault, not being installed or otherwise included, etc. In such circumstances, it can be challenging for control strategy to know whether or not the vehicle may be substantially driven post-refueling, whether the vehicle will be parked and for how long, etc. Accordingly, within the scope of this disclosure is the ability for a vehicle operator to initiate a tank cooling event in advance of a refueling event, or a parking event where the vehicle will be stored for some amount of time in a nonoperational state (e.g., not traveling across a surface). In one aspect, the vehicle operator can initiate tank cooling operations via an HMI in the vehicle cab, or otherwise. In some aspects, depressing a button or otherwise indicating a request for refueling, can cause the control strategy to initiate tank cooling operation as described.

In one aspect a cooling system is provided for vehicles with a cryogenic tank. The system comprises a cryogenic tank comprising a cooling system, wherein the cooling system comprises a para-ortho catalyst device and a chiller and wherein the cryogenic tank is configured to store a cryogenic fluid; and a controller storing instructions in non-transitory memory that, when executed, cause the controller to conduct a cooling operation for the cryogenic tank via one or more of the para-ortho catalyst device and the chiller as a function of operating conditions.

In aspects, the cryogenic fluid is a liquid hydrogen.

In aspects, the system is a component of a vehicle, and the operating conditions are vehicle operating conditions.

In aspects, the para-ortho catalyst device comprises a para-ortho catalyst, wherein the para-ortho catalyst comprises one or more of a paramagnetic material, an activated carbon, a platinized asbestos, a rare earth metal, a uranium compound, a nickel compound, thoria, ruthenium, copper, platinum, palladium, manganese, and ferric oxide, silver.

In aspects, the para-ortho catalyst device is coupled with a heat exchanger device to form a catalyst heat exchanger assembly.

In aspects, the heat exchanger device is located such that a cooling effect from an endothermic reaction resulting from conversion of para hydrogen to ortho hydrogen by the para-ortho catalyst device is transferred to surroundings to cool contents of the cryogenic tank.

In aspects, the para-ortho catalyst device is configured to be located near a region of the cryogenic tank where a temperature of an ullage gas is predicted to be highest measured over a period of time.

In aspects, the chiller comprises one or more heat exchangers.

In aspects, the chiller is one of a thermoacoustic chiller and a thermoacoustic Stirling chiller.

In aspects, the chiller is a pulse tube thermoacoustic chiller.

In aspects, at least a part of the chiller is located in a region comprising the cryogenic fluid.

In aspects, the system further comprises one or more sensors.

In aspects, the sensors comprise a temperature sensor, a pressure sensor, a fluid level sensor, and a flow sensor.

In aspects, the system further comprises a bypass circuit configured to vent an ullage gas to exit the cryogenic tank.

In aspects, the system further comprises one or more fluid pathways controlled via one or more valves to control an ullage gas in the one or more fluid pathways wherein the one or more fluid pathways comprise a first pathway and a second pathway, wherein the first pathway comprises the para-ortho catalyst device, and the second pathway comprises a bypass circuit.

In aspects, the system further comprises actuators, wherein the actuators are configured to control the one or more valves.

In aspects, the controller is configured to operate the actuators automatically based on the operating conditions.

In aspects, the controller receives a signal generated manually by an operator and the controller then proceeds to control the actuators.

In aspects, the vehicle operating conditions comprise one or more of a tank temperature, a tank pressure, a level of the cryogenic fluid, weather conditions, route conditions, a refueling need, a distance from refueling station, driving distance post refueling, and a parking time.

In aspects, the para-ortho catalyst device is operated via the controller when a first set of conditions is met comprising a subset of the vehicle operating conditions.

In aspects, the first set of conditions are based on determination of one or more of the tank pressure above a pressure threshold, the tank temperature above a temperature threshold, and the vehicle is in operation.

In aspects, meeting the first set of conditions is determined by one of a control logic, and a human operator.

In aspects, the chiller is operated via the controller when a second set of conditions is met comprising a subset of the vehicle operating conditions.

In aspects, the second set of conditions are based on determination of one or more of a refueling requirement based on a fuel level below a level threshold a distance from a refueling station, a driving distance post refueling above a distance threshold, availability of an on-board energy supply unit, a condition of the onboard energy supply unit, availability of shore power, and parking time above a time threshold.

In aspects, the distance from the refueling station and the driving distance post refueling is determined using a predictive route module and a current location obtained via global positioning system (GPS).

In aspects, meeting the second set of conditions is determined by one of a control logic, and a human operator.

In aspects, the chiller is operated via the controller when a third set of conditions are met comprising a subset of the vehicle operating conditions.

In aspects, the third set of conditions are based on determination of one or more of the tank pressure above a pressure threshold, the tank temperature above the temperature threshold, a fuel level is above a level threshold, availability of secondary fuel sources, condition of the secondary fuel sources, and when the vehicle is in operation.

In aspects, meeting the third set of conditions is determined by one of a control logic, and a human operator.

In aspects, the para-ortho catalyst device is powered when the vehicle is in operation when one or more of a tank pressure is above a pressure threshold and a tank temperature is above a temperature threshold.

In aspects, the chiller is powered when the vehicle is in operation with a fuel level above a level threshold and when one or more of a tank pressure is above a pressure threshold and a tank temperature is above a temperature threshold.

In aspects, the chiller is powered when the vehicle is in operation with a secondary fuel source being available and when one or more of a tank pressure is above a pressure threshold and a tank temperature is above a temperature threshold.

In aspects, the chiller is powered when the vehicle is parked and plugged into an external power source and when one or more of a tank pressure is above a pressure threshold and a tank temperature is above a temperature threshold.

In another aspect, a method is provided for vehicles for cooling a cryogenic tank. The method comprises determining, operating conditions based on data received from one or more sensors of a vehicle, wherein the vehicle comprises a cryogenic tank and wherein the cryogenic tank is configured to hold a cryogenic fluid and an ullage gas in an ullage space of the cryogenic tank; sending a signal by a controller to operate, via one or more actuators, one or more of a chiller and a para-ortho catalyst device based on the operating conditions; and operating one or more of the chiller and the para-ortho catalyst device.

In aspects, the operating conditions comprise a first set of conditions, wherein the first set of conditions are based on a determination of one or more of a tank pressure above a pressure threshold, a tank temperature above a temperature threshold, and the vehicle in operation.

In aspects, the operating conditions comprise a second set of conditions, wherein the second set of conditions are based on determination of one or more of a refueling requirement, a distance from a refueling station, and a driving distance post refueling.

In aspects, the operating conditions comprise a third set of conditions, wherein the third set of conditions are based on determination of one or more of a tank pressure above a pressure threshold, a tank temperature above a temperature threshold, a fuel level, availability of secondary fuel sources, condition of the secondary fuel sources, and the vehicle is in operation.

In aspects, the actuators comprise one or more valves for controlling a passage of cryogenic gas through the para-ortho catalyst device and a bypass circuit.

In aspects, a control logic is configured for determining the operating conditions meeting a criterion is based on one of a control logic comprising a rule-based system.

In aspects, the signal to the controller is sent by a control logic based on a determination of operating conditions being met or by a human operator via a button activating the controller.

In aspects, the sending of the signal is one of automated, based on the control logic, and manual based on a human operator.

In aspects, the para-ortho catalyst device is powered when the vehicle is in operation when one or more of a tank pressure is above a pressure threshold and a tank temperature is above a temperature threshold.

In aspects, the chiller is powered when the vehicle is in operation with a fuel level above a level threshold and when one or more of a tank pressure is above a pressure threshold and a tank temperature is above a temperature threshold.

In aspects, the chiller is powered when the vehicle is in operation with a secondary fuel source being available and when one or more of a tank pressure is above a pressure threshold and a tank temperature is above a temperature threshold.

In aspects, the chiller is powered when the vehicle is parked and plugged into an external power source and when one or more of a tank pressure is above a pressure threshold, a tank temperature is above a temperature threshold, and a fuel level is above a level threshold.

In another aspect, a non-transitory computer-readable medium having stored thereon instructions executable by a computer system is provided for vehicles for cooling a cryogenic tank.

The non-transitory computer-readable medium having stored thereon instructions executable by a computer system to perform operations comprises determining, operating conditions based on data received from one or more sensors of a vehicle, wherein the vehicle comprises a cryogenic tank and wherein the cryogenic tank is configured to hold a cryogenic fluid and an ullage gas in an ullage space of the cryogenic tank; sending a signal by a controller to operate, via one or more actuators, one or more of a chiller and a para-ortho catalyst device based on the operating conditions; and operating one or more of the chiller and the para-ortho catalyst device.

In aspects, a control logic is configured for determining the operating conditions meeting a criterion is based on one of a control logic comprising a rule-based system.

In aspects, the signal to the controller is sent by a control logic based on a determination of operating conditions being met or by a human operator via a button activating the controller.

In another aspect, a system is provided for vehicles for cooling a cryogenic tank via use of a catalyst and heat-exchanger assembly and a chiller. The system for a vehicle comprising a tank configured for storing a cryogen; a catalyst and heat-exchanger assembly; a chiller; and a controller storing instructions in non-transitory memory that, when executed, cause the controller to supply a consumer of the cryogen with said cryogen in a manner in which said cryogen contacts the catalyst of the catalyst and heat-exchanger assembly; and power said chiller.

In aspects, the cryogen is selected from the group consisting of hydrogen, nitrogen, and liquid natural gas (LNG).

In aspects, said cryogen is hydrogen.

In aspects, the consumer is a fuel cell.

In aspects, the consumer is a H2-internal combustion engine (ICE).

In aspects, the system further comprises an onboard energy storage device.

In aspects, the onboard energy storage device is a battery.

In aspects, the battery is a high voltage battery.

In aspects, energy to power said chiller comes from the energy storage device.

In aspects, said cryogen exists in a liquid phase and in a gas phase in the tank; and wherein said chiller is included in the tank in a position where said chiller contacts cryogen in the liquid phase.

In aspects, said cryogen contacts the catalyst in the gas phase.

In another aspect, a system is provided for vehicles for cooling a cryogenic tank. A system for a vehicle comprising a tank configured for storing a cryogen; a catalyst and heat-exchanger assembly; a chiller; and a controller storing instructions in non-transitory memory that, when executed, cause the controller to receive a request to refuel the tank; and conduct a pre-refuel tank cooling operation by relying on both the catalyst and heat-exchanger assembly and the chiller.

In aspects, the controller stores further instructions to conduct the pre-refuel tank cooling operation by controlling cryogen to contact the catalyst while also actuating the chiller.

In another aspect, a system is provided for vehicles for cooling a cryogenic tank when a tank pressure is above a pressure threshold. The system for a vehicle comprising a cryogenic tank configured for storing a cryogen; a catalyst and heat-exchanger assembly; a chiller; and a controller storing instructions in non-transitory memory that, when executed, cause the controller to determine that a pressure in the cryogenic tank is above a pressure threshold; and perform one or more of: drawing an ullage gas in a manner in which said ullage gas contacts the catalyst of the catalyst and the heat-exchanger assembly; and powering said chiller.

In another aspect, a method is provided for vehicles for cooling a cryogenic tank when a tank pressure is above a pressure threshold. The method comprising determining, a tank pressure based on data received from one or more sensors of a vehicle, wherein the vehicle comprises a cryogenic tank and wherein the cryogenic tank is configured to hold a cryogenic fluid and an ullage gas in an ullage space of the cryogenic tank; sending a signal by a controller to operate, via one or more actuators, one or more of a chiller and a para-ortho catalyst device; and operating one or more of the chiller and the para-ortho catalyst device to cool the cryogenic tank.

In another aspect, a system is provided for vehicles for cooling a cryogenic tank via a chiller relying on onboard energy supply. The system for a vehicle comprising a cryogenic tank configured for storing a cryogen a catalyst and heat-exchanger assembly; a chiller; and a controller storing instructions in non-transitory memory that, when executed, cause the controller to receive a request to refuel the cryogenic tank; and conduct a pre-refuel tank cooling operation by relying on the chiller wherein the chiller draws power from an onboard energy supply.

In aspects, the onboard energy supply is one of an energy storage device and a secondary fuel cell.

In aspects, the energy storage device is a battery.

In aspects, the controller determines a state of charge (SOC) of the battery is above a SOC threshold before supplying power to the chiller.

In aspects, the controller further determines a distance to be driven post-refueling.

In another aspect, a method is provided for vehicles for cooling a cryogenic tank via a chiller relying on onboard energy supply. The method comprising determining a refuel event for a cryogenic tank; sending a signal by a controller to operate, via one or more actuators, a chiller; and conducting a pre-refuel tank cooling operation by relying on the chiller wherein the chiller draws power from an onboard energy supply.

In another aspect, a system is provided for vehicles for cooling a cryogenic tank via a chiller relying on offboard energy supply. The system for a vehicle comprising a tank configured for storing a cryogen; a catalyst and heat-exchanger assembly; a chiller; and a controller storing instructions in non-transitory memory that, when executed, cause the controller to determine that the vehicle is being parked for a parking time; and conduct a tank cooling operation by relying on the chiller, wherein the chiller draws power from offboard energy supply.

In aspects, the parking time is one of greater than 10 minutes, greater than 20 minutes, greater than 40 minutes, greater than 1 hour, and greater than 2 hours.

In aspects, the system further determines one or more of fuel level above a pressure threshold where tank over-pressurization is likely or predicted to occur, ambient temperature above an ambient temperature threshold, humidity above a humidity threshold, tank temperature above a tank temperature threshold.

In aspects, the offboard energy supply is one of a grid power, a charging station, and a portable generator.

In aspects, the controller further determines a level of fuel in the tank.

In another aspect, a method is provided for vehicles for cooling a cryogenic tank via a chiller relying on offboard energy supply. The method comprising determining that a vehicle is being parked for a parking time; and sending a signal by a controller to operate, via one or more actuators, a chiller; and conducting a tank cooling operation by relying on the chiller, wherein the chiller draws power from offboard energy supply.

In another aspect, a system is provided for vehicles for a cryogenic tank for alerting a driver to schedule a refuel event after a prolonged parking. The system for a vehicle comprising a tank configured for storing a cryogen; a catalyst and heat-exchanger assembly; a chiller; and a controller storing instructions in non-transitory memory that, when executed, cause the controller to determine a need for a refuel event; determine that the vehicle will be parked for a parking time; and alert a driver of the vehicle with an alert signal for the refuel event to be scheduled after the parking time.

In aspects, the system further determines a post refueling driving distance using predictive route module.

In another aspect, a method is provided for vehicles for a cryogenic tank for alerting a driver to schedule a refuel event after a prolonged parking. The method comprising determining a need for a refuel event; determining that a vehicle will be parked for a parking time; and alerting a driver of the vehicle with an alert signal for the refuel event to be scheduled after the parking time.

In another aspect, a system is provided for vehicles for cooling a cryogenic tank via a chiller. The system for a vehicle comprising a tank configured for storing a cryogen; a catalyst and heat-exchanger assembly; a chiller; and a controller storing instructions in non-transitory memory that, when executed, cause the controller to determine that the vehicle will be parked for a predetermined parking time; use the cryogen in a fuel cell to charge an energy storage device associated with the vehicle; and conduct a tank cooling operation by relying on the chiller, where the chiller is powered by the energy storage device.

In aspects, the energy storage device is a battery.

In aspects, the controller determines a state of charge (SOC) of the battery is above a SOC threshold before supplying power to the chiller.

In aspects, the state of charge of the battery is above a SOC threshold is variable and depends on the parking time.

In another aspect, a method is provided for vehicles for cooling a cryogenic tank via a chiller. The method comprising determining that a vehicle will be parked for a parking time; using a cryogen in a fuel cell to charge an energy storage device associated with the vehicle; and conducting a tank cooling operation by relying on a chiller, where the chiller is powered by the energy storage device.

In one or more aspects, the system is designed such that the cryogenic tank is maintained at desirable conditions using various methods and control logic, as described herein, based on operating conditions to substantially reduce or completely eliminate the ullage gas.

For simplicity and clarity of illustration, it should be noted that the figures illustrate the general manner of construction. Descriptions and details of well-known features and techniques may be omitted to avoid unnecessarily obscuring the present disclosure. Additionally, elements in the figures are not necessarily drawn to scale. For example, the dimensions of some of the elements in the figures may be exaggerated relative to other elements to help improve understanding of aspects of the present disclosure. The same reference numerals in different figures denotes the same elements.

Although the detailed description herein contains many specifics for the purpose of illustration, a person of ordinary skill in the art will appreciate that many variations and alterations to the details are considered to be included herein.

Accordingly, the aspects herein are without any loss of generality to, and without imposing limitations upon, any claims set forth. The terminology used herein is for the purpose of describing particular aspects only and is not limiting. Unless defined otherwise, all technical and scientific terms used herein have the same meaning as commonly understood by one with ordinary skill in the art to which this disclosure belongs. The following terms and phrases, unless otherwise indicated, shall be understood to have the following meanings.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

The terms “first”, “second”, “third”, “fourth”, and the like in the description and in the claims, if any, are used for distinguishing between similar elements and not necessarily for describing a particular sequential or chronological order. It is to be understood that the terms so used are interchangeable under appropriate circumstances such that the aspects described herein are, for example, capable of operation in sequences other than those illustrated or otherwise described herein. Furthermore, the terms “include” and “have” and any variations thereof, are intended to cover a non-exclusive inclusion, such that a process, method, system, article, device, or apparatus that comprises a list of elements is not necessarily limited to those elements but may include other elements not expressly listed or inherent to such process, method, system, article, device, or apparatus.

The terms “left”, “right”, “front”, “back”, “top”, “bottom”, “over”, “under”, and the like in the description and in the claims, if any, are used for descriptive purposes and not necessarily for describing permanent relative positions. It is to be understood that the terms so used are interchangeable under appropriate circumstances, such that the aspects of the apparatus, methods, and/or articles of manufacture described herein are, for example, capable of operation in other orientations than those illustrated or otherwise described herein.

No element, act, or instruction used herein should be construed as critical or essential unless explicitly described as such. Also, as used herein, the articles “a” and “an” are intended to include items and may be used interchangeably with “one or more”. Furthermore, as used herein, the term “set” is intended to include items (e.g., related items, unrelated items, a combination of related items and unrelated items, etc.), and may be used interchangeably with “one or more”. Where only one item is intended, the term “one” or similar language is used. Also, as used herein, the terms “has”, “have”, “having”, and the like are intended to be open-ended terms. Further, the phrase “based on” is intended to mean “based, at least in part, on” unless explicitly stated otherwise.

As used herein, the terms “couple,” “coupled,” “couples,” “coupling,” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably,” “removable,” and the like, near the word “coupled” and the like does not mean that the coupling, etc. in question is or is not removable.

As used herein, the term “or” means an inclusive “or” rather than an exclusive “or.” That is, unless specified otherwise, or clear from context, “X employs A or B” means any of the natural inclusive permutations. That is, if X employs A; X employs B; or X employs both A and B, then “X employs A or B” is satisfied under any of the foregoing instances.

As used herein, the term “real-time” refers to operations conducted as soon as practically possible upon occurrence of a triggering event. A triggering event can include receipt of input data necessary to execute a task or to otherwise process information. Because of delays inherent in transmission and/or in computing speeds, the term “real-time” encompasses operations that occur in “near” real-time or somewhat delayed from a triggering event. In a number of aspects, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many aspects, the time delay can be less than approximately one second, two seconds, five seconds, or ten seconds. For example, input data processed within milliseconds so that it is available virtually immediately.

As used herein, the term “approximately” or “substantially” can mean within a specified or unspecified range of the specified or unspecified stated value. In some aspects, “approximately” can mean within plus or minus ten percent of the stated value. In other aspects, “approximately” can mean within plus or minus five percent of the stated value. In further aspects, “approximately” can mean within plus or minus three percent of the stated value. In yet other aspects, “approximately” can mean within plus or minus one percent of the stated value.

Other specific forms may embody the present disclosure without departing from its spirit or characteristics. The described aspects are in all respects illustrative and not restrictive. Therefore, the appended claims rather than the description herein indicate the scope of the disclosure. All variations which come within the meaning and range of equivalency of the claims are within their scope.

As used herein the term “component” refers to a distinct and identifiable part, element, or unit within a larger system, structure, or entity. It is a building block that serves a specific function or purpose within a more complex whole. Components are often designed to be modular and interchangeable, allowing them to be combined or replaced in various configurations to create or modify systems. Components may be a combination of mechanical, electrical, hardware, firmware, software and/or other engineering elements.

Digital electronic circuitry, or in computer software, firmware, or hardware, including the structures disclosed in this specification and their structural equivalents, or in combinations of one or more of them may realize the implementations and all of the functional operations described in this specification. Implementations may be as one or more computer program products i.e., one or more modules of computer program instructions encoded on a computer readable storage medium for execution by, or to control the operation of, data processing apparatus. The computer readable storage medium may be a machine-readable storage device, a machine-readable storage substrate, a memory device, a composition of matter affecting a machine-readable propagated signal, or a combination of one or more of them.

The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus. A control system, for example control system 214 comprising a controller 212 of FIG. 2, is an exemplary computing system. A controller is a device and/or algorithm designed to manage, regulate, or guide the behavior of a system, for example a cooling system, by adjusting inputs, for example powering a chiller. A Proportional-Integral-Derivative (PID) controller is an exemplary controller.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of a digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc. may embed a computer. Computer readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship with each other.

Aspects may comprise or utilize a special purpose or general-purpose computer including computer hardware. Aspects within the scope of the present disclosure may also include physical and other computer readable media for carrying or storing computer-executable instructions and/or data structures. Such computer readable media can be any media accessible by a general purpose or special purpose computer system. Computer readable media that store computer-executable instructions are physical storage media. Computer readable media that carry computer-executable instructions are transmission media. Thus, by way of example and not limitation, aspects can comprise at least two distinct kinds of computer readable media: physical computer readable storage media and transmission computer readable media.

Although the present aspects described herein are with reference to specific example aspects it will be evident that various modifications and changes may be made to these aspects without departing from the broader spirit and scope of the various aspects. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer readable media includes combinations of the above, that enable the transport of electronic data between computer systems and/or modules and/or other electronic devices.

Further, upon reaching various computer system components, program code in the form of computer-executable instructions or data structures can be transferred automatically from transmission computer readable media to physical computer readable storage media (or vice versa). For example, computer-executable instructions or data structures received over a network or data link can be buffered in RAM within a Network Interface Circuit (NIC), and then eventually transferred to computer system RAM and/or to less volatile computer readable physical storage media at a computer system. Thus, computer system components that also (or even primarily) utilize transmission media may include computer readable physical storage media.

Computer-executable instructions comprise, for example, instructions and data which cause a general-purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer readable media such as computer memory may practice the methods. In particular, one or more processors execute computer-executable instructions, stored in the computer memory, to perform various functions such as the acts recited in the aspects.

Those skilled in the art will appreciate that the disclosure may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the disclosure. In a distributed system environment, program modules may be located in both local and remote memory storage devices.

The aspects described herein include examples of systems and computer-implemented methods. It is, of course, not possible to describe every conceivable combination of components and/or computer-implemented methods for purposes of describing the one or more aspects, but one of ordinary skill in the art can recognize that many further combinations and/or permutations of the one or more aspects are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

Aspects of the one or more aspects described herein are described with reference to flowchart illustrations and/or block diagrams of methods, apparatus (systems), and computer program products according to one or more aspects described herein. Each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more aspects described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

As used herein, a “sensor” is a device that measures physical input from its environment and converts it into data that is interpretable by either a human or a machine. Most sensors are electronic, which presents electronic data, but some are simpler, such as a glass thermometer, which presents visual data.

In an aspect, sensors may be removably or fixedly installed within the vehicle and may be disposed in various arrangements, in some examples to provide information to autonomous operation features. Among the sensors may be included one or more of a GPS unit, a radar unit, a LIDAR unit, an ultrasonic sensor, an infrared sensor, an inductance sensor, a camera, an accelerometer, a tachometer, a temperature sensor, a pressure sensor, or a speedometer. Some of the sensors (e.g., radar, LIDAR, or camera units) may actively or passively scan the vehicle environment for obstacles (e.g., other vehicles, buildings, pedestrians, etc.), roadways, lane markings, signs, or signals. Other sensors (e.g., GPS, accelerometer, or tachometer units) may provide data for determining the location or movement of the vehicle (e.g., via GPS coordinates, dead reckoning, wireless signal triangulation, etc.).

As used herein, the term “control logic” includes, but is not limited to the set of algorithms, rules, or procedures embedded within a system or device that governs its behavior and operational decisions. This logic is typically implemented in software and hardware to manage and regulate the functioning of mechanical, electrical, or electronic systems. Control logic determines how a system responds to various inputs and conditions, enabling it to achieve desired outputs and performance levels. It encompasses a range of techniques and methodologies, including feedback loops, decision-making processes, and state-based operations, to ensure the system operates efficiently, reliably, and in accordance with specified requirements.

As used herein, the term “cryogenic tank” includes, but is not limited to a tank that is used for the storage of cryogenic liquids at extremely low temperatures, typically below −150 degrees Celsius (−238 degrees Fahrenheit).

As used herein, the term, “cryogen” or “cryogenic fluid” broadly encompasses any substance that is in a fluid state (either liquid or gas) at cryogenic temperatures, typically below −150° C. (−238° F.). A cryogenic fluid can therefore be either a cryogenic liquid or a cryogenic gas, depending on the specific temperature and pressure conditions. Common examples include liquid hydrogen, liquid nitrogen, liquid oxygen, and gaseous helium when stored or used at cryogenic temperatures. Cryogenic fluids are fluids with a boiling point below −130° F. (−90° C.). In an aspect, cryogenic fluid is selected from the group comprising: liquefied natural gas, liquefied petroleum gas, liquid nitrogen, liquid hydrogen, liquid oxygen and any combination thereof.

As used herein, the term “vehicle” includes, but is not limited to, a machine designed for the purpose of transporting people or goods from one location to another. For example, vehicle may include motor vehicles in general such as passenger automobiles including sports utility vehicles (SUV), buses, trucks, various commercial vehicles, watercraft including a variety of boats and ships, aircraft, spacecraft, and the like, and includes fuel cell electric vehicles (FCEVs), hybrid electric vehicles, electric vehicles, plug-in hybrid electric vehicles, hydrogen-powered vehicles with an internal combustion engine (H₂-ICE), and other alternative fuel vehicles (e.g. fuels derived from resources other than petroleum).

As used herein, the term “ortho state of hydrogen” or “ortho hydrogen” includes, but is not limited to, a form of molecular hydrogen (H₂) where the spins of both protons in the hydrogen nuclei are aligned in the same direction, resulting in parallel spin orientations. This alignment creates a triplet state with higher energy compared to the para state.

As used herein, the term “para state of hydrogen” or “para hydrogen” includes, but is not limited to, a form of molecular hydrogen (H₂) in which the spins of the two protons in the hydrogen nuclei are oriented in opposite directions, resulting in antiparallel spin alignment. This configuration leads to a singlet state with lower energy compared to the ortho state.

As used herein, the term “catalyst” includes, but is not limited to, a substance that increases the rate of a chemical reaction without itself undergoing any permanent chemical change. Catalysts work by providing an alternative reaction pathway with a lower activation energy, thereby allowing the reaction to proceed more quickly or at lower temperatures than it would without the catalyst.

As used herein, the term “Para-ortho catalyst” includes, but is not limited to, specialized materials used to facilitate the conversion between the two spin isomers of molecular hydrogen parahydrogen to orthohydrogen. The conversion between parahydrogen and orthohydrogen in cryogenic applications is important particularly for the storage and handling of liquid hydrogen. Para-ortho catalysts are used to accelerate the conversion from para to ortho when a thermal balance is needed, such as in certain cooling processes of the cryogenic tank.

As used herein, the term “Para-ortho catalyst device” includes, but is not limited to, a device or apparatus comprising para-ortho catalyst designed to convert the parahydrogen to orthohydrogen. It is a component or sub-system of a catalyst and heat exchanger device.

As used herein, the term “vaporization” includes, but is not limited to, the process by which a liquid, typically a cryogenic fluid, vaporizes or evaporates due to the heat it absorbs over time. This phenomenon occurs when the temperature of the liquid rises above its boiling point, leading to the conversion of some or all of the liquid into gas.

As used herein, the term “chiller” includes, but is not limited to, a mechanical device used to remove heat from a liquid through various means, including but not limited to vapor-compression, absorption, adsorption refrigeration cycle, thermoacoustics, and so on. “Chiller” encompasses thermoacoustic chillers (e.g., thermoacoustic Stirling chiller) amongst other types.

As used herein, the term “thermoacoustics” includes, but is not limited to, the field of study that explores the interaction between temperature gradients, heat flow, and sound waves within a medium. The primary focus is on how temperature differences within a gas or fluid can generate acoustic waves (sound) and, conversely, how sound waves can induce temperature changes. This interdisciplinary area combines principles from thermodynamics, fluid dynamics, and acoustics.

As used herein, the term “thermoacoustic chiller” includes, but is not limited to, a type of refrigeration system that utilizes thermoacoustic effects to achieve cooling. This technology leverages the interaction between sound waves and thermal gradients to transfer heat and produce a cooling effect.

As used herein, the term “thermoacoustic Stirling chiller” includes, but is not limited to, a hybrid cooling system that combines principles from both thermoacoustic and Stirling engine technologies. It operates by leveraging the thermoacoustic effect to drive a Stirling cycle for refrigeration purposes. While the system utilizes thermoacoustic effect, i.e., use sound waves to create temperature gradients within a resonator and to induce acoustic oscillations in the system, the Stirling engine operates based on the cyclic compression and expansion of a working gas, which absorbs and rejects heat during its cycle. The thermoacoustic effect helps drive the Stirling engine, which in turn enhances the refrigeration process. As used herein, the term “cooling system” includes, but is not limited to, a mechanical or electronic arrangement designed to dissipate heat from a device, process, fluid, or space to maintain a desired or preset operating temperature. It may comprise one or more independent cooling devices and technologies that may be controlled or used to impart cooling. Cooling systems as herein described can include those with a chiller and/or catalyst and heat exchanger.

As used herein, the term “ullage space” includes, but is not limited to, the unfilled space in a container or tank that is intentionally left empty to accommodate the expansion and contraction of the liquid contained within the tank, particularly for volatile or cryogenic liquids. “Ullage” or “ullage space” generally includes, but is not limited to, a portion of a container or tank that isn't filled with liquid.

As used herein, the term “ullage gas” includes, but is not limited to, a gas present in the ullage or ullage space of a container or tank (e.g., cryogenic fuel tank). Hydrogen liquid in a cryogenic tank will vaporize to become hydrogen gas, or ullage gas, for example.

As used herein, the term “fuel cell” includes, but is not limited to, an electrochemical device that converts the chemical energy of a fuel, typically hydrogen, directly into electrical energy through a chemical reaction with oxygen or another oxidizing agent.

As used herein, the term “heat exchanger” includes, but is not limited to, a device designed to transfer heat from one medium to another. Heat exchangers may be used in both cooling and heating processes. The media may be separated by a solid wall to prevent mixing or may be in direct contact.

As used herein, the term “endothermic reaction” includes, but is not limited to, a chemical reaction that absorbs energy from its surroundings in the form of heat. During this type of reaction, the products have higher energy than the reactants, resulting in a net intake of energy. This absorption of heat causes the temperature of the surrounding environment to decrease. Endothermic reactions are characterized by a positive change in enthalpy (ΔH >0).

As used herein, the term “exothermic reaction” includes, but is not limited to, a chemical reaction that releases energy to its surroundings in the form of heat or light. During this type of reaction, the products have lower energy than the reactants, resulting in a net release of energy. This release of heat causes the temperature of the surrounding environment to increase. Exothermic reactions are characterized by a negative change in enthalpy (ΔH <0).

As used herein, the term “open valve” includes, but is not limited to, a valve that allows fluid to flow through the pipeline or system. An open valve need not be fully open to be considered open, for example a partially open valve is an “open” valve. A “fully open” valve includes, but is not limited to, a valve which is opened to its maximum extent.

As used herein, the term “closed valve” includes, but is not limited to, a valve that blocks fluid flow completely, preventing any movement of the fluid through the system.

As used herein, the term “proportional valve” or “digital control valve” or “continuously variable valve” is a type of control valve that allows for precise control of fluid flow. The valve can be programmed to open or close to specific positions, providing fine control overflow rate and pressure. Such valves may be operated or controlled by digital signals, often through an actuator or control system. These types of valves can be integrated with electronics to enable precise and programmable control over its degree of opening.

As used herein, the term “vehicle sensing system” includes, but is not limited to, a combination of technologies and devices integrated into a vehicle and/or its environment to detect, monitor, and analyze various parameters related to the vehicle's operation, surroundings, and occupants. These systems provide real-time data and enable automated responses. For example, vehicle sensing system comprises one or more of Radar sensors, LIDAR sensors, ultrasonic sensors, cameras, infrared sensors, inertial measurement units (IMUs), tire pressure monitoring systems (TPMS), occupant detection systems, and environmental sensors.

As used herein, the term “operating conditions” include a set of conditions, parameters, and/or environmental factors in which a particular system or a device is operating.

The descriptions of the one or more aspects are for purposes of illustration but are not exhaustive or limiting to the aspects described herein. Many modifications and variations will be apparent to those of ordinary skill in the art without departing from the scope and spirit of the described aspects. The terminology used herein best explains the principles of the aspects, the practical application and/or technical improvement over technologies found in the marketplace, and/or to enable others of ordinary skill in the art to understand the aspects described herein.

### INCORPORATION BY REFERENCE

All references, including granted patents and patent application publications, referred herein are incorporated herein by reference in their entirety.
U.S. Pat. No. 9,777,889B2 titled as “vapor cooled shielding liner for cryogenic storage in composite pressure vessels”;
U.S. Ser. No. 10/323,794B2 titled as “hydrogen fueling systems and methods”;
U.S. Ser. No. 10/435,294B2 titled as “para-orthohydrogen conversion using a vortex tube”;
US20070289974A1 titled as “cryogenic insulation systems with nanoporous components”;
U.S. Pat. No. 6,430,938B1 titled as “cryogenic vessel system with pulse tube refrigeration”;
U.S. Pat. No. 7,739,909B2 titled as “acoustic fluid level monitoring”;
US20230139191A1 titled as “hydrogen tank, method of cooling a hydrogen tank, and vehicle having a hydrogen drive and hydrogen tank”;
U.S. Ser. No. 10/144,535B2 titled as “cryogenic hydrogen radiation shield for human spaceflight”;
U.S. Pat. No. 7,228,686B2 titled as “cryogenic refrigeration system for superconducting devices”;
US20070006597A1 titled as “cryogenic tank system”;
US20110265493A1 titled as: “Thermoacoustic Apparatus With Series-Connected Stages”.

What is claimed is:

1. A system comprising:
a cryogenic tank comprising a cooling system, wherein the cooling system comprises a para-ortho catalyst device and a chiller;
one or more sensors configured for sensing parameters of the cooling system; and
a controller in communication with the one or more sensors and storing instructions in non-transitory memory that, when executed, cause the controller to conduct a cooling operation for the cryogenic tank via one or more of the para-ortho catalyst device and the chiller as a function of operating conditions;
wherein the para-ortho catalyst device comprises a para-ortho catalyst;
wherein the cryogenic tank is configured to store a cryogenic fluid;
wherein at least a part of the chiller is located in a region comprising the cryogenic fluid; and
wherein the one or more sensors comprise a temperature sensor, a pressure sensor. a fluid level sensor, and a flow sensor.

2. The system of claim 1, wherein the system is a component of a vehicle, and the operating conditions are vehicle operating conditions, and wherein the vehicle operating conditions comprise one or more of a tank temperature, a tank pressure, a level of the cryogenic fluid, weather conditions, route conditions, a refueling need, a distance from refueling station, driving distance post refueling, and a parking time.

3. The system of claim 2, wherein the para-ortho catalyst device is operated via the controller when a first set of conditions is met comprising a subset of the vehicle operating conditions, wherein the first set of conditions are based on determination of one or more of the tank pressure above a pressure threshold, the tank temperature above a temperature threshold, and the vehicle is in operation.

4. The system of claim 2, wherein the chiller is operated via the controller when a second set of conditions is met comprising a subset of the vehicle operating conditions, wherein the second set of conditions are based on determination of one or more of a refueling requirement based on a fuel level below a level threshold, the distance from the refueling station, the driving distance post refueling above the distance threshold, availability of an onboard energy supply unit, a condition of the onboard energy supply unit, availability of shore power, and the parking time above a time threshold.

5. The system of claim 2, wherein the chiller is operated via the controller when a third set of conditions are met comprising a subset of the vehicle operating conditions, wherein the third set of conditions are based on determination of one or more of the tank pressure above a pressure threshold, the tank temperature above a temperature threshold, a fuel level is above a level threshold, availability of secondary fuel sources, condition of the secondary fuel sources, and when the vehicle is in operation.

6. The system of claim 2, wherein the chiller is powered when the vehicle is in operation with a fuel level above a level threshold and when one or more of the tank pressure is above a first pressure threshold and the tank temperature is above a first temperature threshold, or wherein the chiller is powered when the vehicle is in operation with a secondary fuel source being available and when one or more of the tank pressure is above a second pressure threshold and the tank temperature is above a second temperature threshold, or wherein the chiller is powered when the vehicle is parked and plugged into an external power source and when one or more of the tank pressure is above a third pressure threshold and the tank temperature is above a third temperature threshold.

7. The system of claim 1, wherein the para-ortho catalyst device is coupled with a heat exchanger device to form a catalyst heat exchanger assembly, and wherein the heat exchanger device is located such that a cooling effect from an endothermic reaction resulting from conversion of para hydrogen to ortho hydrogen by the para-ortho catalyst device is transferred to surroundings to cool contents of the cryogenic tank.

8. The system of claim 1, wherein the chiller comprises one or more heat exchangers.

9. The system of claim 1, wherein the system further comprises a bypass circuit configured to vent an ullage gas to exit the cryogenic tank.

10. The system of claim 1, wherein the system further comprises one or more fluid pathways controlled via one or more valves to control an ullage gas in the one or more fluid pathways wherein the one or more fluid pathways comprise a first pathway and a second pathway, wherein the first pathway comprises the para-ortho catalyst device, and the second pathway comprises a bypass circuit.

11. The system of claim 3 wherein the instructions when executed cause the controller to:
supply a consumer of the cryogenic fluid with the cryogenic fluid in a manner in which the cryogenic fluid contacts the catalyst of a catalyst and heat-exchanger assembly; and
power said chiller.

12. The system of claim 3 wherein the instructions when executed cause the controller to:
receive a request to refuel the cryogenic tank; and
conduct a pre-refuel tank cooling operation by relying on the chiller wherein the chiller draws power from an onboard energy supply.

13. The system of claim 3 wherein the instructions when executed cause the controller to:
determine that the tank pressure in the cryogenic tank is above the pressure threshold; and
perform one or more of:
drawing an ullage gas in a manner in which said ullage gas contacts the para-ortho catalyst of a catalyst and heat-exchanger assembly; and
powering said chiller.

14. The system of claim 3, wherein the instructions when executed cause the controller to:
determine that the vehicle is being parked for the parking time, and in response to determining that the vehicle is being parked for the parking time:
conduct a tank cooling operation by relying on the chiller, wherein the chiller draws power from offboard energy supply; or
use the cryogenic fluid in a fuel cell to charge an energy storage device associated with the vehicle and conduct the tank cooling operation using the chiller, wherein the chiller is powered by the energy storage device.

15. A method comprising:
determining, operating conditions based on data received from one or more sensors of a vehicle, wherein the vehicle comprises a cryogenic tank and wherein the cryogenic tank is configured to hold a cryogenic fluid and an ullage gas in an ullage space of the cryogenic tank;
sending a signal by a controller to operate, via one or more actuators, one or more of a chiller and a para-ortho catalyst device based on the operating conditions; and
operating one or more of the chiller and the para-ortho catalyst device in response to the signal;
wherein the actuators comprise one or more valves for controlling a passage of cryogenic gas through the para-ortho catalyst device and a bypass circuit; and
wherein the signal to the controller is sent by a control logic based on a determination of the operating conditions being met or by a human operator via a user input activating the controller.

16. The method of claim 15, wherein the operating conditions comprise a first set of conditions, wherein the first set of conditions are based on determination of one or more of a tank pressure above a pressure threshold, a tank temperature above a temperature threshold, and the vehicle in operation.

17. The method of claim 15, wherein the operating conditions comprise a second set of conditions, wherein the second set of conditions are based on determination of one or more of a refueling requirement, a distance from a refueling station, and a driving distance post refueling.

18. The method of claim 15, wherein the operating conditions comprise a third set of conditions, wherein the third set of conditions are based on determination of one or more of a tank pressure above a pressure threshold, a tank temperature above a temperature threshold, a fuel level, availability of secondary fuel sources, condition of the secondary fuel sources, and the vehicle is in operation.

19. The method of claim 15,
wherein the para-ortho catalyst device is powered when the vehicle is in operation when one or more of a tank pressure is above a first pressure threshold and a tank temperature is above a first temperature threshold, and
wherein the chiller is powered when the vehicle is in operation with a fuel level above a first fuel level threshold and when one or more of the tank pressure is above a second pressure threshold and the tank temperature is above a second temperature threshold, or
wherein the chiller is powered when the vehicle is in operation with a secondary fuel source being available and when one or more of the tank pressure is above a third pressure threshold and the tank temperature is above a third temperature threshold, or
wherein the chiller is powered when the vehicle is parked and plugged into an external power source and when one or more of the tank pressure is above a fourth pressure threshold, the tank temperature is above a fourth temperature threshold, and the fuel level is above a second fuel level threshold.

20. A non-transitory computer-readable medium having stored thereon instructions executable by a computer system to perform operations comprising:
determining, operating conditions based on data received from one or more sensors of a vehicle, wherein the vehicle comprises a cryogenic tank and wherein the cryogenic tank is configured to hold a cryogenic fluid and an ullage gas in an ullage space of the cryogenic tank;
sending a signal by a controller to operate, via one or more actuators, one or more of a chiller and a para-ortho catalyst device based on the operating conditions; and
operating one or more of the chiller and the para-ortho catalyst device in response to the signal.
